(19) United States
(12) Patent Application Publication
(10) Pub. No.: US 2025/0285849 A1
(43) Pub. Date: Sep. 11, 2025

(54) DATA INDEPENDENT ACQUISITION (DIA) USING ION SEPARATION

(71) Applicants: Thermo Fisher Scientific (Bremen) GmbH, Bremen (DE); Thermo Finnigan LLC, San Jose, CA (US)

(72) Inventors: Kyle Fort, Bremen (DE); Brian Adamson, San Jose, CA (US); Alexander A. Makarov, Bremen (DE); Eloy R. Wouters, San Jose, CA (US)

(73) Assignees: Thermo Fisher Scientific (Bremen) GmbH, Bremen (DE); Thermo Finnigan LLC, San Jose, CA (US)

(21) Appl. No.: 19/075,203

(22) Filed: Mar. 10, 2025

Related U.S. Application Data
(60) Provisional application No. 63/563,856, filed on Mar. 11, 2024.

(51) Int. Cl. H01J 49/00; G01N 27/623; G01N 27/624

(52) U.S. Cl. CPC H01J 49/0031; G01N 27/623; G01N 27/624; H01J 49/0036; H01J 49/0045

(57) ABSTRACT

A method of operating an analytical instrument comprises ionising a sample to produce sample ions; (i) performing a first ion separation scan by separating sample ions according to a first physico-chemical property, and analysing the separated sample ions by performing one or more MS1 mass analysis scans; and (ii) performing a second ion separation scan by separating sample ions according to the first physico-chemical property, and analysing the separated sample ions by performing a plurality of MS2 mass analysis scans. Each MS2 scan of the plurality of MS2 mass analysis scans uses one MS2 isolation window of a plurality of MS2 isolation windows. The method further comprises analysing MS1 data acquired from the one or more MS1 mass analysis scan(s), and configuring the plurality of MS2 isolation windows based on the analysis of the MS1 data.

### CROSS REFERENCE TO RELATED APPLICATION

This application claims priority to U.S. Provisional Patent Application No. 63/563,856, filed Mar. 11, 2024, which is incorporated by reference herein.

### FIELD

The present invention relates to the field of mass spectrometry, and in particular to mass spectrometry incorporating ion separation such as ion mobility separation.

### BACKGROUND

The application of mass spectrometry to proteomics and similar fields is commonly performed with two different data acquisition methodologies: Data Dependent Acquisition (DDA) and Data Independent Acquisition (DIA).

FIG. 1 illustrates schematically a typical DIA workflow, wherein a sample is separated with liquid chromatography (LC) and ionised into a mass spectrometer (MS). The mass spectrometer is configured to perform a single MS1 scan (light hatched boxes in FIG. 1) that covers an entire m/z region of interest, and this scan is followed by a series of MS2 scans (dark hatched boxes in FIG. 1) using various small mass filter m/z isolation windows that, when integrated across the entire series of MS2 scans, covers the m/z region analysed by the initial MS1 scan. This combination of an MS1 scan and the subsequent MS2 scans is termed a cycle, and this cycle is repeated many times throughout the LC gradient. As a single LC elution profile is on the order of multiple seconds, and the cycle time is typically 1-2 seconds, multiple cycles can occur over the elution profile, thereby facilitating identification and quantification of the sample ions.

It is believed that there remains scope for improvements to methods of and apparatus for mass spectrometry.

### SUMMARY

A first aspect provides a method of operating an analytical instrument comprising:
ionising a sample to produce sample ions;
(i) performing a first ion separation scan by separating sample ions according to a first physico-chemical property, and analysing the separated sample ions by performing one or more MS1 mass analysis scan(s); and
(ii) performing a second ion separation scan by separating sample ions according to the first physico-chemical property, and analysing the separated sample ions by performing a plurality of MS2 mass analysis scans, wherein each MS2 scan of the plurality of MS2 mass analysis scans uses one MS2 isolation window of a plurality of MS2 isolation windows.

The method may further comprise analysing MS1 data acquired from the one or more MS1 mass analysis scan(s), and configuring the plurality of MS2 isolation windows based on the analysis of the MS1 data.

Embodiments are directed to methods of operating an analytical instrument such as a mass spectrometer. The instrument may comprise an ion source configured to generate ions from a sample, an ion separator arranged downstream of the ion source and configured to separate received ions according to a first physico-chemical property, a mass filter arranged downstream of the ion separator and configured to filter received ions according to their mass to charge ratio (m/z) (i.e. using an isolation window that has a centre mass to charge ratio (m/z) and a width), a fragmentation device arranged downstream of the mass filter and configured to selectively fragment received ions, and a mass analyser arranged downstream of the mass filter and/or of the fragmentation device and configured to mass analyse received ions. The inclusion of an ion separation device (such as an ion mobility (IM) separator, a differential ion mobility separator, or a device configured to separate ions according to their mass to charge ratio (m/z)) is beneficial as this improves the duty cycle and the sensitivity of the instrument.

The inventors have recognised that for analytical instruments that include ion separation such as ion mobility (IM) separation, the conventional DIA workflow will no longer function. As is described in more detail below, this is because the previous correlation between MS1 and MS2 scans is no longer present, so that sample ions of interest will not normally be present in the MS2 scans. Embodiments described herein provide a new data acquisition strategy that facilitates DIA methods using instruments having an ion separation device such as IM-MS instruments.

In the method, the analytical instrument can perform a Data Independent Acquisition (DIA) method by performing one or more MS1 mass analysis scan(s) during a first ion separation scan, followed by performing a plurality of MS2 mass analysis scans during a second, e.g. immediately subsequent, ion separation scan. The instrument may perform one or more further pluralities of MS2 mass analysis scans during one or more (immediately) subsequent ion separation scan(s). These steps may be repeated, e.g. so that the analytical instrument repeatedly switches between performing MS1 mass analysis scan(s) and MS2 mass analysis scans.

In the method, each MS2 scan of the plurality of MS2 mass analysis scans uses a different MS2 isolation window of a plurality of MS2 isolation windows. That is, the mass filter's isolation window is controlled to be different in each MS2 scan of the plurality of MS2 mass analysis scans performed during the second (or third, or fourth, etc.) ion separation scan.

Furthermore, each MS2 isolation window is configured, at least in part, based on analysis of MS1 data acquired from the one or more MS1 mass analysis scans. As is described further below, by configuring the plurality of MS2 isolation windows based on the analysis of the MS1 data, the sensitivity and/or duty cycle of the instrument can be significantly improved. Thus, the method provides an improved DIA workflow for an instrument comprising an ion separator.

The analytical instrument may be a mass spectrometer, e.g. comprising an ion source. Ions may be generated from a sample in the ion source. The ion source may be coupled to a chromatographic separation device such as a liquid chromatography (LC) separation device, a gas chromatography (GC) separation device, etc., such that the sample which is ionised in the ion source comes from the chromatographic separation device.

The analytical instrument may comprise an ion separator arranged downstream of the ion source, and configured to perform ion separation scans to separate ions received from the ion source according to the first physico-chemical property. The ion separator can be an ion mobility separator, in which case each ion separation scan is an ion mobility separation scan and the first physico-chemical property is ion mobility. Alternatively, the ion separator can be a differential ion mobility separator, in which case each ion separation scan is a differential ion mobility separation scan and the first physico-chemical property is differential ion mobility. Alternatively, the ion separator can be a device configured to separate ions according to their mass to charge ratio (m/z), in which case each ion separation scan is a mass to charge ratio (m/z) separation scan and the first physico-chemical property is mass to charge ratio (m/z). Further details of various possible types of ion separators are provided below.

The ion separator may be operable in a cyclical manner, i.e. to repeatedly perform ion separation scans. In each ion separation scan the ion separator may receive ions from the ion source, and e.g. accumulate a packet of ions in an accumulation region. Alternatively, packets of ions may be accumulated in an ion trap upstream of the ion separator. The ion separator may then separate the packet of ions according to the ions' first physico-chemical property, e.g. by passing the packet of ions through an ion separation region. Ions with a higher value of the first physico-chemical property reach the end of the ion separation region (and leave the separator) ahead of ions with a lower value of the first physico-chemical property (or vice versa).

Each ion separation scan may have a duration T_{IMS}. In other words, the ion separator may have a cycle time T_{IMS}. The duration T_{IMS} may include the time required to accumulate a packet of ions together with the time required to separate ions. Alternatively, the duration T_{IMS} may correspond only to the time required to separate ions, where the accumulation of a packet of ions is performed in parallel with the separation of a previously accumulated packet of ions. The duration T_{IMS} may be on the order of hundreds or a few thousands of milliseconds. The duration T_{IMS} may be constant within any given experiment, but may be varied between experiments by suitable control of the instrument.

The analytical instrument may comprise a mass filter arranged downstream of the ion separator, and configured to receive separated ions from the ion separator. The mass filter can be any suitable mass filter that is operable to filter ions according to their m/z, such as a quadrupole mass filter. The mass filter may be configured such that received ions having m/z within an m/z isolation window are isolated and onwardly transmitted by the mass filter, while received ions having m/z outside the m/z isolation window are attenuated by the mass filter, e.g. are not onwardly transmitted by the mass filter. The width and/or the centre m/z of the isolation window may be controllable (variable), e.g. by suitable control of RF and/or DC voltage(s) applied to the mass filter. Thus, for example, the mass filter may be operable in a transmission mode of operation, whereby most or all ions within a relatively wide m/z isolation window are onwardly transmitted by the mass filter, and a filtering mode of operation, whereby only ions within a relatively narrow m/z isolation window (centred at a desired m/z) are isolated and onwardly transmitted by the mass filter.

The analytical instrument may comprise a fragmentation device arranged downstream of the mass filter, and configured to receive ions transmitted by the mass filter. The fragmentation device may be configured to selectively fragment some or all of the received ions, i.e. so as to produce fragment ions. The fragmentation device may be operable in a fragmentation mode of operation, whereby most or all received ions are fragmented so as to produce fragment ions (which may then be onwardly transmitted from the fragmentation device), and a non-fragmentation mode of operation, whereby most or all received ions are onwardly transmitted without being (deliberately) fragmented. It would also be possible for a non-fragmentation mode of operation to be implemented by causing ions to bypass the fragmentation device.

The analytical instrument may comprise a mass analyser arranged downstream of the fragmentation device and configured to perform mass analysis scans to determine the mass to charge ratio (m/z) of received ions. The mass analyser may be operable in a cyclical manner, i.e. to repeatedly perform mass analysis scans. In each mass analysis scan the mass analyser receives ions and mass analyses them. The mass analyser may be an ion trap mass analyser, such as an electrostatic orbital trap, and more specifically an Orbitrap™ FT mass analyser. Other types of mass analyser would be possible. For example, the mass analyser may be a time-of-flight (ToF) mass analyser, such as a multi-reflection time-of-flight (MR-ToF) mass analyser.

It would be possible for the instrument to be configured such that ions can be passed to the mass analyser in the form of an ion beam, e.g. without having been accumulated before being passed to the mass analyser. Thus, in embodiments, ions are accumulated directly within the mass analyser. In these embodiments, the number of ions accumulated within the mass analyser may be controlled by controlling an accumulation time (e.g. fill time) of ions into the mass analyser. This in turn may be controlled by operating a gate or lens of the mass analyser and/or a gate or lens within the instrument upstream of the mass analyser (between the ion source and the mass analyser) in an open (transmitting) mode of operation for a desired amount of time (and otherwise operating the gate or lens in a closed (non-transmitting) mode of operation).

However, in particular embodiments, ions are passed to the mass analyser from an ion trap arranged upstream of the mass analyser. Ions may be initially accumulated within the ion trap, and then passed to the mass analyser, e.g. in the form of a packet of ions. The ion trap may be referred to as an injection device for injecting ions into the mass analyser. The ion trap can comprise any suitable ion trap, such as a linear ion trap or a curved linear ion trap (C-trap), e.g. as described WO 2008/081334. The ion trap may be used to cool the accumulated ions prior to injecting them into the mass analyser. The ion trap may also or instead be used (in an MS² mode of operation) as the fragmentation device to fragment ions prior to injecting the fragment ions into the mass analyser. Multiple ion traps could also be used.

In these embodiments, the number of ions accumulated within the mass analyser may be controlled by controlling an accumulation time (e.g. fill time) of ions into the ion trap. This in turn may be controlled by operating a gate or lens of the ion trap and/or a gate or lens within the instrument upstream of the ion trap (between the ion source and the ion trap) in an open (transmitting) mode of operation for a desired amount of time (and otherwise operating the gate or lens in a closed (non-transmitting) mode of operation).

Each mass analysis scan has a duration T_{MA}. In other words, the mass analyser has a cycle time T_{MA}. T_{MA} may include all overheads linked to operation of the mass analyser. The duration T_{MA} may include the time required to accumulate a packet of ions (and optionally to cool and/or fragment those ions, and optionally to inject those ions into the mass analyser) together with the time required to mass analyses those ions. Alternatively, the duration T_{MA} may correspond only to the time required to mass analyse a packet of ions, or only the time required to accumulate a packet of ions (and optionally to cool and/or fragment those ions), where the accumulation of a packet of ions is performed in parallel with the mass analysis of a previously accumulated packet of ions.

In particular embodiments, the mass analysis scan duration T_{MA} is less than the ion separation scan duration T_{IMS}, i.e. T_{MA}<T_{IMS}. In embodiments, the mass analyser is of a type in which the mass analyser scan time T_{MA} is relatively long, e.g. such that two or more, tens or a few hundreds of mass analysis scans can be performed during each ion separation scan. The duration T_{MA} may be on the order of tens or hundreds of milliseconds. The duration T_{MA} may be constant within any given experiment, but may be varied between experiments by suitable control of the instrument.

The analytical instrument may be operable in at least an MS1 mode of operation in which the instrument performs one or more MS1 mass analysis scans, and in an MS2 mode of operation in which the instrument performs one or more MS2 mass analysis scans.

In each MS1 mass analysis scan, the mass filter is operated in its transmission mode or in its filtering mode with a relatively broad isolation window width (e.g. of the order of hundreds or thousands of Th), and ions are not (intentionally) fragmented, so that a relatively broad m/z range of ions produced by the ion source is mass analysed by the mass analyser.

In each MS2 mass analysis scan, the mass filter is operated in its filtering mode with a relatively narrow isolation window width (e.g. of the order of ones or tens of Th) so as to isolate ions, and the isolated ions are fragmented in the fragmentation device, so that a relatively narrow m/z range of ions produced by the ion source is isolated and fragmented, and the resulting fragment ions are mass analysed by the mass analyser.

Each MS1 mass analysis scan may have a duration T_{MS1}, and each MS2 mass analysis scan may have a duration T_{MS2}. Typically, T_{MS1}>T_{MS2} because high resolution data is relatively more important for the MS1 scans, while high speed is relatively more important for the MS2 scans (e.g. so that a much larger number of MS2 scans can be acquired per unit time). Where the instrument is operated in a cyclical manner, typically T_{MS2} may be set as some fraction of T_{MS1}, e.g. T_{MS2}/T_{MS1}=½, ¼, ⅛, 1/16, etc.

In the method of various embodiments, the ion source ionises a sample (e.g. received from the (LC) separation device) to produce sample ions, and the ion separator performs a plurality of repeated ion separation scans, wherein in each ion separation scan the ion separator receives sample ions and separates them according to the first physico-chemical property. At the same time, the mass analyser performs a plurality of repeated mass analysis scans, wherein in each mass analysis scan the mass analyser receives separated sample ions or fragment ions derived from separated sample ions and mass analyses the received ions.

In particular, the analytical instrument may (i) perform one or more MS1 mass analysis scans during a first ion separation scan, and (ii) perform a plurality of MS2 mass analysis scans during a second ion separation scan. The second ion separation scan may immediately follow the first ion separation scan in the plurality of repeated ion separation scans, but this is not necessary. The steps (i) and (ii) may be performed repeatedly, e.g. so that the analytical instrument repeatedly switches between performing MS1 mass analysis scan(s) in one ion separation scan and performing MS2 mass analysis scans is the subsequent ion separation scan (followed by performing MS1 mass analysis scan(s) in the subsequent ion separation scan, and so on).

In further embodiments, each cycle includes more than two ion separation scans. Thus, for example, the method may comprise the analytical instrument performing a plurality of repeated cycles, wherein each cycle comprises any number such as three, four, five or more ion separation scans of the plurality of repeated ion separation scans. Each ion separation scan in a cycle may be directed either to MS1 analysis or to MS2 analysis. There may be one or more (e.g. two, three, four, etc.) MS1-directed ion separation scans in each cycle and one or more (e.g. two, three, four, etc.) MS2-directed ion separation scans in each cycle. The timings of the mass analysis scans and the isolation windows used for each mass analysis scan may be configured so that each ion separation scan in a cycle is directed to a different region of the ion arrival time-m/z space (i.e. the first physico-chemical property-m/z space). However, it would also be possible for a region of the ion arrival time-m/z space to be analysed (reisolated) more than once during a cycle.

In some embodiments, each cycle includes two or more ion separation scans, and MS1 mass analysis scan(s) are performed during the earlier ion separation scan(s) of each cycle and MS2 mass analysis scans are performed during the later ion separation scan(s) of each cycle. For example, each cycle may comprise the analytical instrument (i) performing one or more MS1 mass analysis scans during a first ion separation scan, (ii) performing a first plurality of MS2 mass analysis scans during a second (e.g. immediately subsequent) ion separation scan, (iii) performing a second plurality of MS2 mass analysis scans during a third (e.g. immediately subsequent) ion separation scan, (iv) optionally performing a third plurality of MS2 mass analysis scans during a fourth (e.g. immediately subsequent) ion separation scan, and (v) optionally performing one or more further pluralities of MS2 mass analysis scans during each of one or more further (e.g. immediately subsequent) ion separation scan(s).

Other orderings of MS1 scans and MS2 scans in each cycle would be possible. For example one or more additional MS1-directed ion separation scan(s) may be performed in each cycle, e.g., after the first ion separation scan and before the MS2-directed ion separation scan(s). Thus, although in some embodiments the “second” ion separation scan immediately follows the “first” ion separation scan, in other embodiments there may be one or more ion separation scan(s) between the “first” and “second” ion separation scans in each cycle (and similarly for the “third” and “fourth” ion separation scans).

The analytical instrument may perform the plurality of repeated cycles during an entire chromatographic separation run of the (LC) chromatographic separation device.

During the first ion separation scan of each cycle (and/or during any other MS1-directed ion separation scan), the instrument may perform only one MS1 mass analysis scan, or may perform a plurality of MS1 mass analysis scans. The one or more MS1 mass analysis scans performed during the first (and/or other MS1) ion separation scan of a cycle may together approximately span most or all of the duration T_{IMS} of the first ion separation scan. Thus, where only a single MS1 mass analysis scan is performed during the first (and/or other MS1) ion separation scan, T_{MS1}≈T_{IMS}. Where a plurality of MS1 mass analysis scans is performed during the first (and/or other MS1) ion separation scan, approximately N≈T_{IMS}/T_{MS1} MS1 mass analysis scans may be performed during the first (and/or other MS1) ion separation scan.

The one or more MS1 mass analysis scans performed during the first (and/or other MS1) ion separation scan of a cycle may together span a m/z range of interest. The m/z range of interest can be any suitable m/z range such as e.g. between about 100 and 2000 or similar. Thus, where only a single MS1 mass analysis scan is performed during the first (and/or other MS1) ion separation scan, the mass filter may be operated in its transmission mode or in its filtering mode with a broad isolation window width encompassing the m/z range of interest, so that the MS1 mass analysis scan can determine the mass to charge ratio (m/z) of ions across the entire m/z range of interest.

Where a plurality of MS1 mass analysis scans is performed during the first (and/or other MS1) ion separation scan, each mass analysis scan may be configured to determine the mass to charge ratio (m/z) of ions within a sub-range of the m/z range of interest. Thus, the m/z range of interest may be divided into a plurality of (N) overlapping or non-overlapping m/z sub-ranges, where the plurality of sub-ranges spans the entire m/z range of interest, and where each mass analysis of the plurality of MS1 mass analysis scans is configured to determine the mass to charge ratio (m/z) of ions within a respective different one of the sub-ranges.

To do this, each MS1 scan of the plurality of MS1 mass analysis scans may use one MS1 isolation window from a plurality of different MS1 isolation windows. That is, the mass filter's isolation window may be controlled to be different in each MS1 scan of the plurality of MS1 mass analysis scans performed during the first (and/or other MS1) ion separation scan.

The plurality of MS1 isolation windows may differ from each other in terms of their centre m/zs. That is, each MS1 scan of the plurality of MS1 mass analysis scans may use one MS1 isolation window centre m/z from a plurality of different MS1 isolation window centre m/zs (and the mass filter's isolation window centre m/z may be controlled to be different in each MS1 scan of the plurality of MS1 mass analysis scans).

The plurality of MS1 isolation windows may also differ from each other in terms of their width, although this is not necessary and it would be possible instead for each MS1 scan of the plurality of MS1 mass analysis scans to use the same MS1 isolation window width.

The MS1 isolation window centre m/zs and widths may be selected so that together the plurality of MS1 scans span the entire m/z range of interest. Furthermore, each MS1 isolation window may be selected based on one or more trend lines.

In some embodiments, each trend line corresponds to an ion charge state, and each trend line provides a relationship between ion arrival time and m/z for ions having that charge state. For example, each trend line may provide a relationship between ion mobility arrival time and m/z for ions having that charge state.

It has been recognised that there is a relationship between ion mobility arrival time and m/z for ions of various different charge states (e.g. singly charged, doubly charged, triply charged, etc.). These relationships take the form of a “trend line” in respect of each different charge state. The relationship between ion mobility arrival time and m/z may be approximately linear for ions having a particular charge state, and so may be described by a linear trend line, e.g. in the form of a slope and intercept. However, non-linear trend lines are also possible, depending on the nature of the sample ions. In practice, there will be some spread of arrival times ions for ions having a particular charge and a particular m/z, but typically this spread is sufficiently small that ions of different charge states can be distinguished in most of the ion mobility arrival time-m/z space.

In some embodiments, as well as or instead of charge state, each trend line corresponds to a particular chemical class, where each trend line provides a relationship between ion arrival time and m/z for ions of that chemical class and optionally having that charge state. That is, different chemical classes may have different (charge dependent) trend lines. Examples of a chemical class include peptides derived from tryptic digestion of a protein; a group or mixture of proteins; lipids or a group of lipids; metabolites or a group of metabolites; nucleotides, and so on.

Thus, each trend line may correspond to (i) a particular charge state (e.g. singly charged, doubly charged, triply charged, etc.), (ii) a particular chemical class, or (iii) a particular combination of charge state and chemical class. Each trend line may provide an approximate relationship between ion arrival time and m/z for ions having that charge state and/or that chemical class. Each trendline may be used to determine an approximate expected ion arrival time for sample ions (i) depending on the m/z and charge state of the sample ions, (ii) depending on the m/z and chemical class of the sample ions, or (iii) depending on the m/z, charge state and chemical class of the sample ions.

It would also be possible to define and use a trend line based on some other property of the sample ions.

As is described further below, and as described in more detail in co-pending application U.S. 63/468,170 the entire contents of which is incorporated herein by reference, the one or more trend lines may be determined by performing a calibration for the instrument.

In embodiments, each MS1 isolation window of the plurality of MS1 isolation windows is selected based on one or more of these trend lines. By selecting the MS1 isolation windows based on the one or more trend lines (e.g. by controlling the mass filter's isolation window to track one or more of the trend lines) during the first (and/or other MS1) ion separation scan, it can be ensured that (only) sample ions of interest (e.g. having one or more particular charge state(s) and/or of a particular chemical class of interest) are present in the MS1 scans.

Thus, each MS1 isolation window centre m/z may be selected based on one or more of the trend lines. That is, the centre m/z of the mass filter's isolation window may be configured to track one or more of the trend lines. Thus, for example, where each MS1 isolation window centre m/z is selected based on a single trend line, each MS1 scan's isolation window centre m/z may be (approximately) equal to the m/z value given by the single trend line at the centre (average) arrival time at which that MS1 scan is performed. Where each MS1 isolation window centre m/z is selected based on two or more trend lines, each MS1 scan's isolation window centre m/z may be (approximately) equal to the average m/z value given by those two or more trend lines at the centre (average) arrival time at which that MS1 scan is performed.

Equally, each MS1 isolation window width may be selected based on the one or more trend lines. Thus, for example, where each MS1 isolation window width is selected based on a single trend line, each MS1 isolation window width may be configured such that most or all ions having the charge state and/or chemical class associated with the single trend line are transmitted by the mass filter, and such that most or all ions having a charge state and/or chemical class other than the charge state and/or chemical class associated with the single trend line are attenuated (not transmitted) by the mass filter. Where each MS1 isolation window width is selected based on two or more trend lines, each MS1 isolation window width may be configured such that most or all ions having one of the charge states and/or chemical class associated with the two or more trend lines are transmitted by the mass filter, and such that most or all ions having a charge state and/or chemical class other than one of the charge states and/or chemical class associated with the two or more trend lines are attenuated (not transmitted) by the mass filter.

Thus, in general, the plurality of MS1 isolation windows may be configured such that separated sample ions that have a charge state and/or chemical class corresponding to a charge state and/or chemical class associated with the one or more trend lines are isolated, while separated sample ions that have a charge state and/or chemical class other than a charge state and/or chemical class associated with the one or more trend lines are attenuated.

The MS1 isolation window width used for each MS1 scan in the plurality of MS1 scans may increase with increasing MS1 isolation window centre m/z, so as to better isolate those ions having the desired charge state and/or chemical class and so as to better attenuate ions having other undesired charge states and/or chemical classes.

In particular embodiments, the MS1 isolation windows are selected so that singly charged (1+) ions are excluded from the MS1 scans. Thus, the one or more trend lines on which basis each MS1 isolation window is selected may comprise (only) trend lines for multiply charged ions (and not trend lines for singly charged ions). This allows the maximum charge capacity of the instrument to be used more efficiently.

In particular embodiments, the MS1 isolation windows are selected so that ions with the same charge state(s) and/or chemical class as the ions that are to be selected in the MS2 scans are selected in the MS1 scans. Thus, for example, the MS1 isolation windows for the plurality of MS1 mass analysis scans may be selected based on both a first trend line for a first (e.g. doubly charged) charge state, and a second trend line for a second different (e.g. triply charged) charge state.

As described above, in the method, the instrument performs a plurality of MS2 mass analysis scans during a second (and optionally third, fourth, and/or further) ion separation scan of each cycle.

The number of MS2 mass analysis scans performed during an ion separation scan will depend on the duration T_{MS2} of the MS2 mass analysis scans relative to the duration T_{MS1} of the MS1 mass analysis scans, which as described above can be selected as desired. Approximately M≈N×T_{MS1}/T_{MS2} MS2 mass analysis scans may be performed during an ion separation scan. The plurality of MS2 mass analysis scans performed during an ion separation scan may together approximately span most or all of the duration T_{IMS} of that ion separation scan, but this is not necessary.

In the DIA method of various embodiments, the plurality of MS2 mass analysis scans performed during an ion separation scan may together span the m/z range of interest. Thus, in each MS2 mass analysis scan, the instrument may isolate and fragment ions within a sub-range of the m/z range of interest. Thus, the m/z range of interest may be divided into a plurality of (M) overlapping or non-overlapping m/z sub-ranges, where the plurality of sub-ranges spans the entire m/z range of interest, and where each MS2 scan of the plurality of MS2 scans is configured to isolated and fragment ions having m/z within a respective different one of the sub-ranges.

To do this, each MS2 scan of the plurality of MS2 mass analysis scans uses one MS2 isolation window from a plurality of different MS2 isolation windows. That is, the mass filter's isolation window may be controlled to be different in each MS2 scan of the plurality of MS2 mass analysis scans performed during an ion separation scan.

The plurality of MS2 isolation windows may differ from each other in terms of their centre m/zs. That is, each MS2 scan of the plurality of MS2 mass analysis scans may use one MS2 isolation window centre m/z from a plurality of different MS2 isolation window centre m/zs (and the mass filter's isolation window centre m/z may be controlled to be different in each MS2 scan of the plurality of MS2 mass analysis scans).

The plurality of MS2 isolation windows may also differ from each other in terms of their width, although this is not necessary and it would be possible instead for each MS2 scan of the plurality of MS2 mass analysis scans to use the same MS2 isolation window width.

The MS2 isolation window centre m/zs and widths may be selected so that together the plurality of MS2 scans span the entire m/z range of interest.

In some embodiments, each MS2 isolation window is selected based on one or more trend lines, wherein (as described above) each trend line corresponds to (i) a particular charge state (e.g. singly charged, doubly charged, triply charged, etc.), or (ii) a particular combination of charge state and chemical class. As described above, each trend line may provide an approximate relationship between ion arrival time and m/z for ions having that charge state and optionally that chemical class. Each trendline may be used to determine an approximate expected ion arrival time for sample ions (i) depending on the m/z and charge state of the sample ions, or (ii) depending on the m/z, charge state and chemical class of the sample ions.

By selecting the MS2 isolation windows based on the one or more trend lines (e.g. by controlling the mass filter's isolation window to track one or more of the trend lines) during the second ion separation scan, it can be ensured that (only) sample ions of interest (e.g. having a particular charge and/or chemical class) are isolated and fragmented in the MS2 scans.

As described above, the method comprises analysing MS1 data acquired from the one or more MS1 mass analysis scan(s), and configuring the plurality of MS2 isolation windows based on the analysis of the MS1 data. In particular, the first and/or second and/or third and/or further pluralities of MS2 isolation windows may be configured by selecting, based on the analysis of the MS1 data, the centre m/z and/or the width of one or more or each of the MS2 isolation windows.

In some embodiments, where each MS2 isolation window is selected based on one or more trend lines, configuring the plurality of MS2 isolation windows may comprise selecting the particular charge state(s) and/or chemical class of interest based on the analysis of the MS1 data. That is, only some (and not all) of the trend lines may be selected and analysed by one or more pluralities of MS2 mass analysis scans depending on the MS1 data.

In these embodiments, in the first and/or second and/or third and/or further plurality of MS2 mass analysis scans, each MS2 isolation window centre m/z may be selected based on the one or more of the trend lines. That is, the centre m/z of the mass filter's isolation window may be configured to track one or more of the trend lines. Thus, for example, where each MS2 isolation window centre m/z is selected based on a single trend line, each MS2 scan's isolation window centre m/z may be (approximately) equal to the m/z value given by the singe trend line at the centre (average) arrival time at which that MS2 scan is performed. Where each MS2 isolation window centre m/z is selected based on two or more trend lines, each MS2 scan's isolation window centre m/z may be (approximately) equal to the average m/z value given by those two or more trend lines at the centre (average) arrival time at which that MS2 scan is performed.

Equally, each MS2 isolation window width may also be selected based on the one or more trend lines. Thus, for example, where each MS2 isolation window width is selected based on a single trend line, each MS2 isolation window width may be configured such that most or all ions having the charge state and/or chemical class associated with the single trend line are transmitted by the mass filter, and such that most or all ions having a charge state and/or chemical class other than the charge state and/or chemical class associated with the trend line are attenuated (not transmitted) by the mass filter. Where each MS2 isolation window width is selected based on two or more trend lines, each MS2 isolation window width may be configured such that most or all ions having one of the charge states and/or chemical class associated with the two or more trend lines are transmitted by the mass filter, and such that most or all ions having a charge state and/or chemical class other than one of the charge states and/or chemical class associated with the two or more trend lines are attenuated (not transmitted) by the mass filter.

Thus, the plurality of MS2 isolation windows may be configured such that separated sample ions that have a charge state and/or chemical class corresponding to a charge state and/or chemical class associated with the one or more trend lines are isolated, while separated sample ions that have a charge state and/or chemical class other than a charge state and/or chemical class associated with the one or more trend lines are attenuated.

As described above, the MS2 isolation window width used for each MS2 scan in the first and/or second and/or third and/or further plurality of MS2 scans may increase with increasing MS2 isolation window centre m/z, so as to better isolate those ions having the desired charge state and/or chemical class and so as to better attenuate ions having other undesired charge states and/or chemical class.

In these embodiments, the MS2 isolation windows may be selected so that multiply charged ions of a single charge state are selected, while singly charged (1+) ions are excluded from the MS2 scans. Thus, the one or more trend lines on which basis each MS2 isolation window is selected may comprise a single trend line for multiply charged ions (e.g. doubly charged ions or triply charged ions).

In further embodiments, rather than have a single plurality of MS2 isolation windows track one or more trend lines, the MS2 scans are performed using (i) a first plurality of MS2 mass analysis scans having a first plurality of MS2 isolation windows during the second ion separation scan, (ii) a second plurality of MS2 mass analysis scans having a second plurality of MS2 isolation windows during a third ion separation scan, (iii) optionally a third plurality of MS2 mass analysis scans having a third plurality of MS2 isolation windows during a fourth ion separation scan, and (iv) optionally one or more further pluralities of MS2 mass analysis scans each having a further plurality of MS2 isolation windows during a further ion separation scan.

The first and/or second and/or third and/or further pluralities of MS2 isolation windows may be selected such that the first and/or second and/or third and/or further pluralities of MS2 mass analysis scans together cover a region of ion arrival time-m/z space of interest (e.g. without leaving any gaps in the region). The region of ion arrival time-m/z space of interest may correspond to one or more trend lines of interest, wherein (as described above) each trend line corresponds to an ion charge state and/or chemical class, and each trend line provides a relationship between ion arrival time and m/z for ions having that charge state and/or of that chemical class. For example, the region covered by the pluralities of MS2 isolation windows may correspond to multiply charged ions.

In these embodiments, the plurality of MS1 isolation windows may comprise an integer number N of isolation windows, the first plurality of MS2 isolation windows comprises an integer number M₁ of isolation windows, the second plurality of MS2 isolation windows comprise an integer number M₂ of isolation windows, the third plurality of MS2 isolation windows comprise an integer number M₃ of isolation windows, and/or where present each further plurality of MS2 isolation windows may comprise an integer number M_{f} of isolation windows. M₁, M₂, M₃ and M_{f} may be equal or approximately equal, and may each be a multiple of N.

Each isolation window of the first plurality of MS2 isolation windows may correspond to a respective one of the second and/or third and/or further plurality of MS2 isolation windows, e.g. such that each isolation window of the first plurality of MS2 isolation windows is used at an ion arrival time in the second ion separation scan that corresponds to an ion arrival time in the third and/or fourth and/or further ion separation scan at which the corresponding isolation window of the second and/or third and/or further plurality of MS2 isolation windows is used. Similarly, each MS1 isolation window of the plurality of MS1 isolation windows may correspond to a respective group of MS2 isolation windows of the first and/or second and/or third and/or further plurality of MS2 isolation windows, e.g. such that each MS1 isolation window of the plurality of MS1 isolation windows is used at an ion arrival time in the first ion separation scan that corresponds to an ion arrival time in the second and/or third and/or fourth and/or further ion separation scan at which the corresponding group of MS2 isolation windows of the first plurality of MS2 isolation windows are used.

Thus, at each ion arrival time, there may be a set of corresponding MS2 isolation windows, where each isolation window of the set belongs to one of the second and/or third and/or fourth and/or further ion separation scan. Each MS2 isolation window of a set will have a different centre m/z.

In some embodiments, all the corresponding MS2 isolation windows in a set have approximately the same width. Then, configuring the first and/or second and/or third and/or further pluralities of MS2 isolation windows based on the analysis of the MS1 data may comprise, for each set of corresponding MS2 isolation windows: assigning each MS2 isolation window of the set to one of the second and/or third and/or fourth and/or further ion separation scans based on an ion abundance within each MS2 isolation window of the set. For example, the MS2 isolation window of the set that encompasses the highest abundance of ions may be assigned to the second ion separation scan, the isolation window of the set that encompasses the second highest abundance of ions may be assigned to the third ion separation scan, and so on. This will ensure that regions of the ion arrival time-m/z space of interest that have higher ion abundance are prioritised, i.e. are analysed sooner e.g. in the second ion separation scan. It would, however, be possible to configured to MS2 isolation windows such that regions of the ion arrival time-m/z space of interest that have lower ion abundance are prioritised.

Thus, the method may comprise:
for each of one or more or all of the first plurality of MS2 isolation windows: configuring that MS2 isolation window, based on the MS1 data, to include a higher abundance of ions than a corresponding one of the second plurality of MS2 isolation windows; and/or
for each of one or more or all of the second plurality of MS2 isolation windows: configuring that MS2 isolation window, based on the MS1 data, to include a higher abundance of ions than a corresponding one of the third plurality of MS2 isolation windows; and/or
for each of one or more or all of the third plurality of MS2 isolation windows: configuring that MS2 isolation window, based on the MS1 data, to include a higher abundance of ions than a corresponding one of any further plurality of MS2 isolation windows.

In further embodiments, instead of using the same width for all the corresponding MS2 isolation windows in a set, the widths may be different. For example, the widths may be configured, based on the MS1 data, so that each isolation window of a set includes approximately the same ion abundance.

Thus, configuring the first and/or second and/or third and/or further pluralities of MS2 isolation windows may comprise:
for each of one or more or all of the second plurality of MS2 isolation windows: configuring that MS2 isolation window, based on the MS1 data, to include a same or similar abundance of ions to a corresponding one of the first plurality of MS2 isolation windows; and/or
for each of one or more or all of the third plurality of MS2 isolation windows: configuring that MS2 isolation window, based on the MS1 data, to include a same or similar abundance of ions to a corresponding one of the first plurality of MS2 isolation windows; and/or
for each of one or more or all of the further plurality of MS2 isolation windows: configuring that MS2 isolation window, based on the MS1 data, to include a same or similar abundance of ions to a corresponding one of the first plurality of MS2 isolation windows.

In these embodiments, the method may comprise:
determining a total ion current indicated by the MS1 data; and
for each of one or more or all of the second plurality of MS2 isolation windows: configuring that MS2 isolation window, based on the MS1 data, to include an equal or approximately equal share of the total ion current as a corresponding one of the first plurality of MS2 isolation windows; and/or
for each of one or more or all of the third plurality of MS2 isolation windows: configuring that MS2 isolation window, based on the MS1 data, to include an equal or approximately equal share of the total ion current to a corresponding one of the first plurality of MS2 isolation windows; and/or
for each of one or more or all of the further plurality of MS2 isolation windows: configuring that MS2 isolation window, based on the MS1 data, to include an equal or approximately equal share of the total ion current to a corresponding one of the first plurality of MS2 isolation windows.

As described above, in some embodiments, in each MS2 mass analysis scan, ions are accumulated in an ion store for an accumulation time. In some further embodiments, the method comprises determining the fill time for one or more or each MS2 scan based on the analysis of the MS1 data.

According to a second aspect, there is provided a method of operating an analytical instrument comprising:
ionising a sample to produce sample ions;
(i) performing a first ion separation scan by separating sample ions according to a first physico-chemical property, and analysing the separated sample ions by performing one or more MS1 mass analysis scan(s); and
(ii) performing a second ion separation scan by separating sample ions according to the first physico-chemical property, and analysing the separated sample ions by performing a plurality of MS2 mass analysis scans, wherein in each MS2 mass analysis scan, ions are accumulated in an ion store for an accumulation time;
wherein the method further comprises:
analysing MS1 data acquired from the one or more MS1 mass analysis scan(s); and
determining the accumulation time for one or more or each MS2 scan based on analysis of the MS1 data.

This aspect and these embodiments can, and in embodiments do, included any one or more or each of the optional features described herein.

In this aspect and these embodiments, determining the accumulation time for an MS2 scan may comprises:
using the one or more trend lines and the MS1 data to estimate an ion abundance within the MS2 isolation window for the MS2 scan; and
determining the accumulation time for the MS2 scan based on the estimated ion abundance.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

A further aspect provides an analytical instrument comprising:
an ion source configured to ionise a sample to produce sample ions;
an ion separator configured to separate sample ions according to a first physico-chemical property;
a mass filter configured to filter ions using an isolation window;
a fragmentation device configured to fragment sample ions so as to produce fragment ions;
a mass analyser; and
a control system configured to:
(i) cause the instrument to perform a first ion separation scan by separating sample ions according to the first physico-chemical property, and analysing the separated sample ions by performing one or more MS1 mass analysis scan(s); and
(ii) cause the instrument to perform a second ion separation scan by separating sample ions according to the first physico-chemical property, and analysing the separated sample ions by performing a plurality of MS2 mass analysis scans, wherein each MS2 scan of the plurality of MS2 mass analysis scans uses one MS2 isolation window of a plurality of MS2 isolation windows;
wherein the control system is further configured to:
analyse MS1 data acquired from the one or more MS1 mass analysis scan(s); and
configure the plurality of MS2 isolation windows based on the analysis of the MS1 data.

A further aspect provides an analytical instrument comprising:
an ion source configured to ionise a sample to produce sample ions;
an ion separator configured to separate sample ions according to a first physico-chemical property;
a mass filter configured to filter ions using an isolation window;
a fragmentation device configured to fragment sample ions so as to produce fragment ions;
a mass analyser; and
a control system configured to:
(i) cause the instrument to perform a first ion separation scan by separating sample ions according to the first physico-chemical property, and analysing the separated sample ions by performing one or more MS1 mass analysis scan(s); and
(ii) cause the instrument to perform a second ion separation scan by separating sample ions according to the first physico-chemical property, and analysing the separated sample ions by performing a plurality of MS2 mass analysis scans, wherein in each MS2 mass analysis scan, ions are accumulated in an ion store for an accumulation time;
wherein the control system is further configured to:
analyse MS1 data acquired from the one or more MS1 mass analysis scan(s); and
determine the accumulation time for one or more or each MS2 scan based on analysis of the MS1 data.

These aspects and embodiments can be, and in embodiments are, combined with any one or more or each of the aspects, embodiments and/or optional features described herein.

### BRIEF DESCRIPTION OF THE DRAWINGS

Various embodiments will now be described in more detail with reference to the accompanying Figures, in which:

FIG. 1 illustrates schematically a conventional DIA workflow.

FIG. 2 shows a mass spectrometer that can be operated in accordance with embodiments.

FIG. 3 shows an example plot of ion mobility arrival time versus m/z for peptide ions of different charge states.

FIG. 4 shows the peptide ions from FIG. 3 superimposed onto a schematic illustration of a conventional DIA workflow.

FIG. 5 illustrates schematically a sequence of MS1 scans in accordance with embodiments.

FIG. 6 illustrates schematically a sequence of MS2 scans in accordance with embodiments.

FIG. 7 illustrates schematically a sequence of MS2 scans in accordance with embodiments.

FIG. 8A shows an example chromatographic elution peak.

FIG. 8B illustrates schematically a sequence of MS1 scans in accordance with embodiments.

FIG. 8C illustrates schematically a sequence of MS2 scans in accordance with embodiments.

FIG. 8D illustrates schematically a sequence of MS1 scans in accordance with embodiments.

FIG. 8E illustrates schematically a sequence of MS2 scans in accordance with embodiments.

FIG. 9A illustrates schematically a sequence of MS2 scans in accordance with embodiments.

FIG. 9B illustrates schematically a sequence of MS2 scans in accordance with embodiments.

FIG. 10 illustrates schematically a calibration method in accordance with embodiments.

FIG. 11 shows another example plot of ion mobility arrival time versus m/z for peptide ions of different charge states.

FIG. 12 illustrates schematically a sequence of MS2 scans in accordance with embodiments.

FIG. 13 shows an example MS1 mass spectrum obtained in accordance with embodiments.

FIG. 14 shows the MS1 mass spectrum of FIG. 13 divided equally between four MS2 isolation windows.

FIG. 15 shows the ion population of each of the MS2 isolation windows of FIG. 14.

FIG. 16 shows the four MS2 isolation windows of FIG. 14 rearranged into an ion population-based order.

FIG. 17 shows the MS1 mass spectrum of FIG. 13 divided between four MS2 isolation windows of varying width to achieve approximately equal ion populations.

FIG. 18 shows the ion population of each of the MS2 isolation windows of FIG. 17.

### DETAILED DESCRIPTION

Embodiments described herein relate to the application of mass spectrometry to proteomics and similar fields. Proteomics and similar methods are typically performed with two different data acquisition methodologies: Data Dependent Acquisition (DDA) and Data Independent Acquisition (DIA).

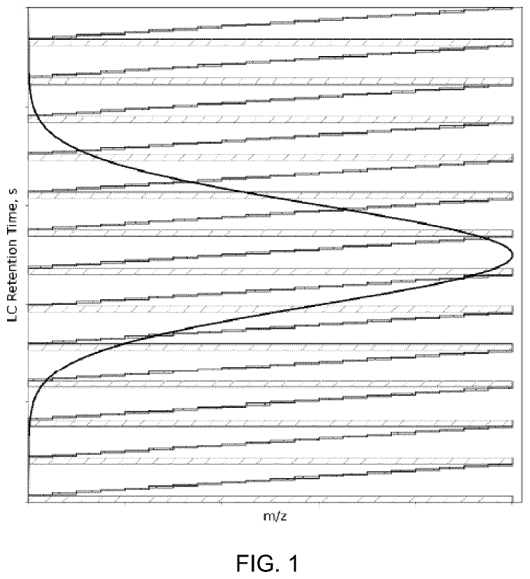

FIG. 1 illustrates a typical DIA workflow, wherein a sample, such as a digest of a proteome, is separated with liquid chromatography (LC) and ionised into a mass spectrometer. An LC elution peak (plotted on the y-axis) is superimposed over an illustration of the traditional DIA acquisition strategy. The mass spectrometer is configured to perform a single MS1 scan (light hatched boxes in FIG. 1) that covers an entire m/z region of interest, and this scan is then followed by a series of MS2 scans (dark hatched boxes in FIG. 1) using various small mass filter m/z isolation windows that, when integrated across the entire series of MS2 scans, covers the m/z region analysed by the initial MS1 scan. In other words, a single MS1 scan is collected for a wide isolation range, and this analysed m/z range is then subdivided into MS2 windows, i.e. narrow m/z regions, which are isolated and subsequently fragmented.

This combination of an MS1 scan and the subsequent MS2 scans is termed a cycle. As shown in FIG. 1, this cycle is repeated many times throughout the LC gradient. As a single LC elution profile is on the order of multiple seconds, and the cycle time, i.e. the time it takes the instrument to collect the MS1 and MS2 scans comprising a single cycle, is typically 1-2 seconds, multiple cycles can occur over the elution profile, thereby facilitating identification and quantification of the sample ions, e.g. peptide ions.

Important to this workflow is the fact that the ion population does not change across the LC elution profile, i.e., the ions analysed in an MS1 scan have the same compositional population as those analysed in the MS2 scans. However, when such LC-MS DIA workflows incorporate an additional separation technique, such as ion mobility, this correlation between MS1 scans and MS2 scans is no longer assured.

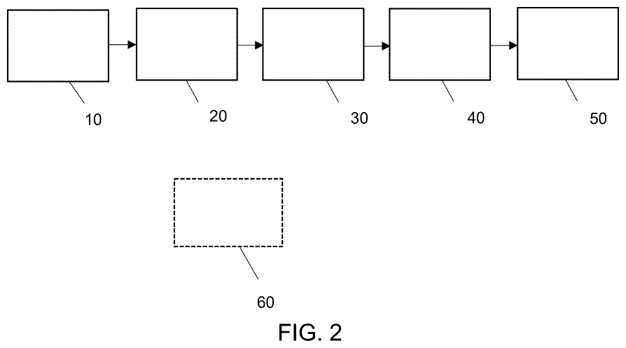

FIG. 2 illustrates schematically an analytical instrument, such as a mass spectrometer (MS), that may be operated in accordance with embodiments. As shown in FIG. 1, the instrument includes an ion source 10, an ion separator 20 such as an ion mobility (IM) separator, a mass filter 30, a fragmentation device 40, and a mass analyser 50.

The ion source 10 is configured to generate ions from a sample. The ion source 10 can be any suitable continuous or pulsed ion source, such as an electrospray ionisation (ESI) ion source, a MALDI ion source, and atmospheric pressure ionisation (API) ion source, a plasma ion source, an electron ionisation ion source, a chemical ionisation ion source, and so on. More than one ion source may be provided and used. The ions may be any suitable type of ions to be analysed, e.g. small and large organic molecules, biomolecules, DNA, RNA, proteins, peptides, fragments thereof and the like.

The ion source 10 may be coupled to a separation device such as a liquid chromatography separation device or a capillary electrophoresis separation device (not shown), such that the sample which is ionised in the ion source 10 comes from the separation device.

The ion separator 20 is arranged downstream of the ion source 10 and is configured to receive ions from the ion source 10. The ion separator 20 is configured to separate received ions according to a first physico chemical property. The first physico-chemical property can be, for example, ion mobility, differential ion mobility, or mass to charge ratio (m/z). Various types of ion separator are described in more detail below.

Where the ion separator 20 is an ion mobility separator, the ion mobility separator may comprise any suitable type of ion mobility separator. For example, an electric field, such as a DC voltage gradient and/or a travelling DC voltage wave, may be arranged to urge ions along the length of the separator and through a gas, so that the ions are separated according to their ion mobility. The ions may optionally be urged against a counter flow of gas or perpendicularly to it. Alternatively, a gas flow may be arranged to urge ions along the length of the separator, while an electric field, such as a DC voltage gradient and/or a travelling DC voltage wave, may be arranged to oppose the gas flow so that the ions are separated according to their ion mobility. The ion mobility separator 20 may be a linear separator with a straight or folded path or a cyclic (closed-loop) separator.

The mass filter 30 is arranged downstream of the ion separator 20 and is configured to receive ions from the ion source 10 (via the ion separator 20). The mass filter 30 is configured to filter the received ions according to their mass to charge ratio (m/z). The mass filter 30 may be configured such that received ions having m/z within an m/z transmission window of the mass filter are onwardly transmitted by the mass filter, while received ions having m/z outside the m/z transmission window are attenuated by the mass filter, e.g. are not onwardly transmitted by the mass filter. The width and/or the centre m/z of the transmission window may be controllable (variable), e.g. by suitable control of RF and/or DC voltage(s) applied to the mass filter 30. Thus, for example, the mass filter 30 may be operable in a transmission mode of operation, whereby most or all ions within a relatively wide m/z window are onwardly transmitted by the mass filter 30, and a filtering mode of operation, whereby only ions within a relatively narrow m/z window (centred at a desired m/z) are onwardly transmitted by the mass filter 30. The mass filter 30 can be any suitable type of mass filter, such as a quadrupole mass filter.

The fragmentation device 40 is arranged downstream of the mass filter 30 and is configured to receive most or all ions transmitted by the mass filter 30. The fragmentation device 40 may be configured to selectively fragment some or all of the received ions, i.e. so as to produce fragment ions. The fragmentation device 40 may be operable in a fragmentation mode of operation, whereby most or all received ions are fragmented so as to produce fragment ions (which may then be onwardly transmitted from the fragmentation device 40), and a non-fragmentation mode of operation, whereby most or all received ions are onwardly transmitted without being (deliberately) fragmented. It would also be possible for a non-fragmentation mode of operation to be implemented by causing ions to bypass the fragmentation device 40. The fragmentation device 40 may also be operable in one or more intermediate modes of operation, e.g. whereby the degree of fragmentation is controllable (variable).

The fragmentation device 40 can be any suitable type of fragmentation device, such as for example a collision induced dissociation (CID) fragmentation device, an electron induced dissociation (EID) fragmentation device, a photodissociation fragmentation device, and so on. Numerous other types of fragmentation are possible.

The mass analyser 50 is arranged downstream of the ion separator 20 and is configured to receive ions from the ion source 10 (via the ion separator 20 and mass filter 30, and optionally via the fragmentation device 40). The mass analyser 50 is configured to analyse the received ions so as to determine their mass to charge ratio and/or mass, i.e. to produce a mass spectrum of the ions. The mass analyser 50 may be an ion trap mass analyser, such as an electrostatic orbital trap mass analyser, and more specifically an Orbitrap™ FT mass analyser.

Thus, the mass analyser 50 may comprise an inner electrode elongated along the orbital trap axis and a split pair of outer electrodes which surround the inner electrode and define therebetween a trapping volume in which ions are trapped and oscillate by orbiting around the inner electrode to which is applied a trapping voltage whilst oscillating back and forth along the axis of the trap. The pair of outer electrodes function as detection electrodes to detect an image current induced by the oscillation of the ions in the trapping volume and thereby provide a detected signal. The outer electrodes typically function as a differential pair of detection electrodes and are coupled to respective inputs of a differential amplifier, which in turn forms part of a digital data acquisition system to receive the detected signal. The detected signal can be processed using Fourier transformation to obtain a mass spectrum of ions within the trap.

It should be noted that FIG. 2 is merely schematic, and that the instrument can, and in embodiments does, include any number of one or more additional components.

For example, the instrument may include one or more ion transfer or trapping stage(s), e.g. arranged between the various illustrated devices. The one or more ion transfer stage(s) may include, e.g., an atmospheric pressure interface and/or one or more ion guides, lenses and/or other ion optical devices configured such that ions can be transferred between the various illustrated devices. The ion transfer stage(s) may include any suitable number and configuration of ion optical devices, for example optionally including one or more RF and/or multipole ion guides, one or more ion guides for cooling ions, one or more mass selective ion guides, and so on.

As also shown in FIG. 2, the instrument is under the control of a control unit 60, such as an appropriately programmed computer, which controls the operation of various components of the instrument. The control unit 60 may also receive and process data from various components including the analyser 50. The control unit 60 is configured, amongst other things, to determine the settings for the ion separator 20, mass filter 30, fragmentation device 40, and the mass analyser 50 for analytical scans.

For example, the control system 60 may cause the instrument to perform one or more MS1 scans, wherein in each MS1 scan the mass filter 30 is operated in its transmission mode or in its filtering mode and ions are not (intentionally) fragmented, so that a broad m/z range of ions produced by the ion source 10 is mass analysed by the mass analyser 50. The control system 60 may also cause the instrument to perform one or more MS2 scans, wherein in each MS2 scan the mass filter 30 is operated in its filtering mode and ions are fragmented in the fragmentation device 40, so that a narrow m/z range of ions produced by the ion source 10 is selected and fragmented, and the resulting fragment ions are mass analysed by the mass analyser 50.

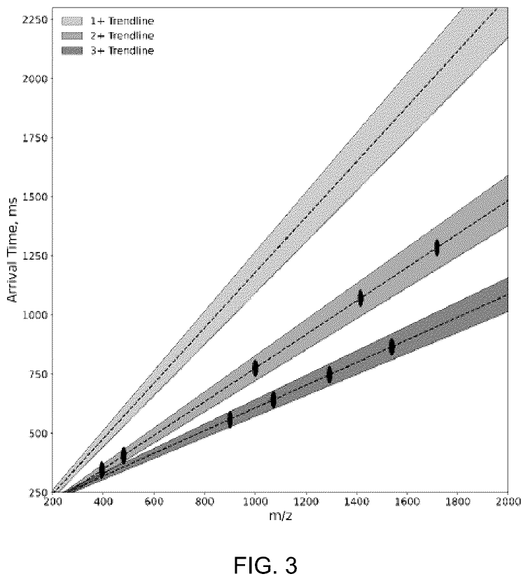

As described above, with dispersive ion mobility (IM) separation techniques, ions are injected into the IM separator 20 and separate in time reflective of the individual ion species' mobility. FIG. 3 shows an example representation of eight peptide ions that are separated with IM-MS. As illustrated by FIG. 3, the peptide ions, represented as black ellipses, fall on distinct, charge-dependent trendlines in arrival time-m/z space. FIG. 3 shows example trendlines for singly charged (1+) ions, doubly charged (2+) ions, and triply charged (3+) ions. Thus, the result of IM separation is various peptide ions concentrated into charge-dependent trendlines in arrival time-m/z space, which elute from the IM separator 20 in distributions with temporal widths of several tens of milliseconds across the entire IM separation time (typically 1-2 seconds).

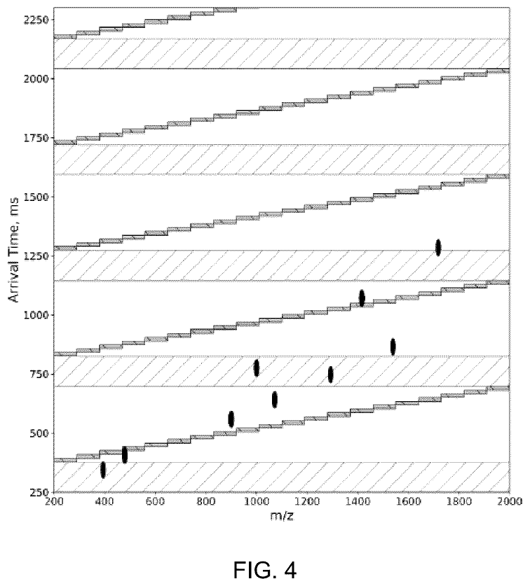

FIG. 4 shows the same eight example peptides (black ellipses) superimposed on to a representation of a standard DIA acquisition scheme, where the light hatched boxes are representative of MS1 scans and the smaller, dark hatched boxes are representative of MS2 scans. As can be seen from FIG. 4, owing to the separation in the IM domain, this acquisition strategy will not function as the overlap between m/z area analysed and arrival time is not present. Moreover, because the MS2 scans occur at a greater arrival time than the preceding MS1 scan, the correlation between MS1 and MS2 is no longer present.

Thus, as is illustrated by FIG. 4, when DIA is performed in an LC-IM-MS setup, the traditional MS acquisition strategy no longer samples the same ion populations in the MS1 and MS2 scans, i.e., the ions present in the MS1 scan would no longer be present when the MS2 scans take place due to their separation in the IM arrival time domain. This obstructs the ability to identify and quantify the peptide ions using this traditional acquisition methodology. As such, a new acquisition strategy is required.

Embodiments described herein provide new data acquisition strategies to allow for DIA measurements with LC-IM-MS instrument configurations. As described above, important to the success of a DIA measurement is the correlation between the MS1 and MS2 scans, i.e., these scans should analyse the same ion types. The acquisition strategies described herein ensure this correlation. Some embodiments optionally also effectively utilise the IM separation to direct the mass spectrometer toward informative, multiply charged ions.

Important to the operation of some embodiments is the fact that while the ion population varies in time during an LC-IM-MS experiment (see FIG. 4) due to separation in the IM domain, this IM separation does remain consistent for the same ion population for multiple IM injections across an elution LC peak. Therefore, as a uniform population of ions is eluting from a single chromatographic peak, the IM separation for these ions will be reproducible and can be used to correlate MS1 and MS2 scans.

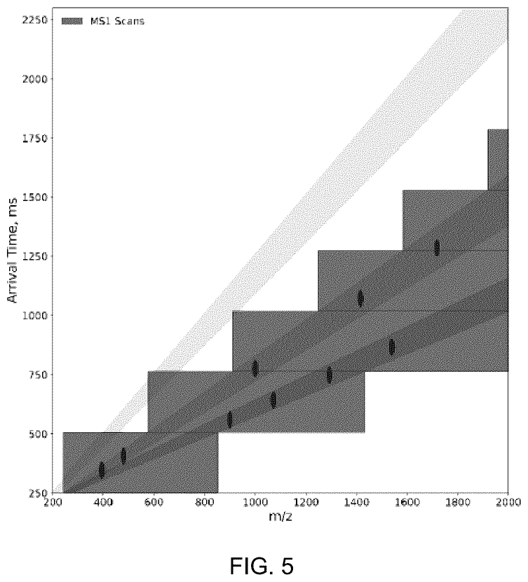

FIG. 5 illustrates a first step of a method in accordance with embodiments. Multiple MS1 scans (dark grey boxes) are collected in a series, where the number of MS1 scans is defined by the maximum arrival time desired to be analysed. Unlike in a standard DIA acquisition, all the MS1 scans are collected in a sequence during a single IM injection. In FIG. 5, the arrival time that is investigated by each MS1 scan is represented by the box height and the mass filter isolation width is reflected by the box width. In the example of FIG. 5, the m/z regions analysed by each MS1 scan are derived from the 2+ and 3+trendlines; however, this mass analyser isolation can be driven by a single charge state trendline and/or other charge states, e.g. 4+ or 5+, as required by the application. It can be seen that, in the example of FIG. 5, all the peptide ion signals (black ellipses) are analysed in an MS1 scan.

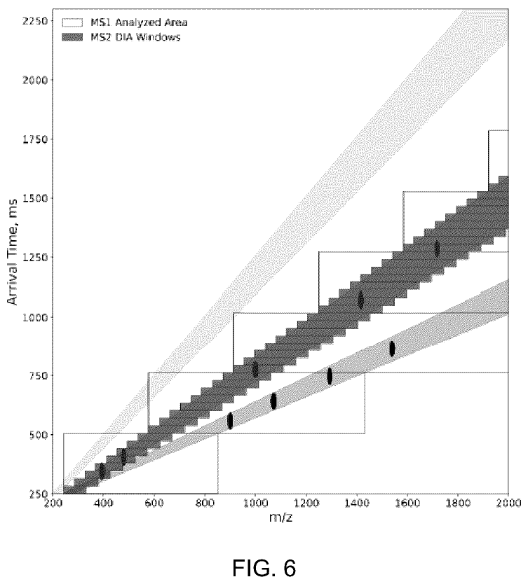

After this sequence of MS1 scans is collected, in a second step, another packet of ions from the LC elution peak is injected into the IM separator 20. FIG. 6 illustrates one embodiment of this second step. As shown in FIG. 6, the method uses the previous MS1 scan boundary conditions (black outlines in FIG. 6) as boundaries for the MS2 scans (dark grey boxes in FIG. 6). In this example, the transient time of the MS2 allows for eight MS2 scans to be obtained per MS1 scan window from the previous injection (but other numbers of MS2 scans are possible).

Thus, firstly MS1 scans are acquired for a single IM injection where the m/z regions analysed with each MS1 scan is dictated by charge state trendlines of interest (which in FIG. 5 are the 2+ and 3+charge states). On the next IM injection, the method then acquires MS2 scans (dark grey boxes in FIG. 6) within the m/z region analysed by the MS1 scans (black box frames in FIG. 6). In the example shown in FIG. 6, the MS2 scans are focused on the 2+trendline and the mass filter isolation of each scan is driven by the boundaries of that trendline; however, the MS2 scans can focus on other and/or additional trendlines as described further below.

Once this series of MS2 scans is acquired, the mass spectrometer will acquire a new set of MS1 scans on the next IM injection.

Thus, with this acquisition strategy, the mass spectrometer cycle may be comprised of two IM injections where the first IM injection is analysed by a plural number N of MS1 scans and the second IM injection is analysed by a plural number M of MS2 scans, where N is defined by Equation 1 and M is defined by Equation 2:

$$N = \frac{{MaximumArrivalTime}_{IM}}{{TransientLength}_{{MS}_{1}}} , \qquad ( 1 )$$

$$M = N \times \frac{{TransientLength}_{{MS}_{1}}}{{TransientLength}_{{MS}_{2}}} . \qquad ( 2 )$$

This cycle scheme is continuously applied throughout the entire LC gradient length. Once the data is acquired, the post-processing data analysis tools will need information from N MS1 scans and M MS2 scans to perform the correlation. In the example shown, for a single cycle, the peptides present in the first MS1 scan are fragmented in the first through eighth MS2 scans; the peptides present in the second MS1 scan are fragmented in the ninth through sixteenth MS2 scans; and so on.

As described above, in the example shown in FIG. 6, the 2+trendline is exclusively analysed; however, this is not required. For example, the MS2 scans can follow any charge state trendline or can cover multiple trendlines, e.g., both the 2+ and 3+ ions simultaneously.

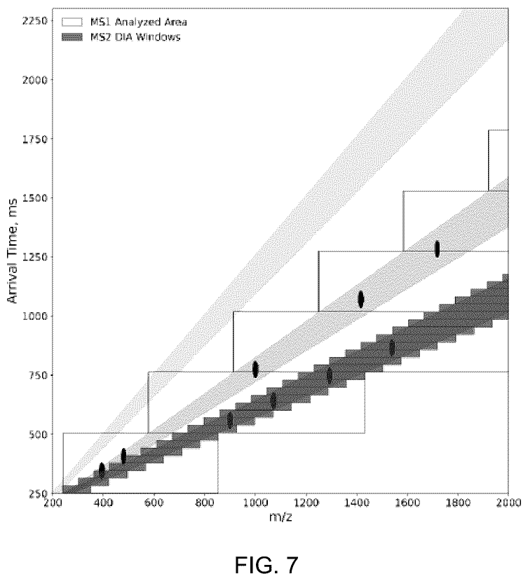

FIG. 7 illustrates an example where the MS2 scans are directed toward the 3+trendline ions. As shown in FIG. 7, the MS2 scans have mass filter isolation windows directed by this charge-state's boundary conditions.

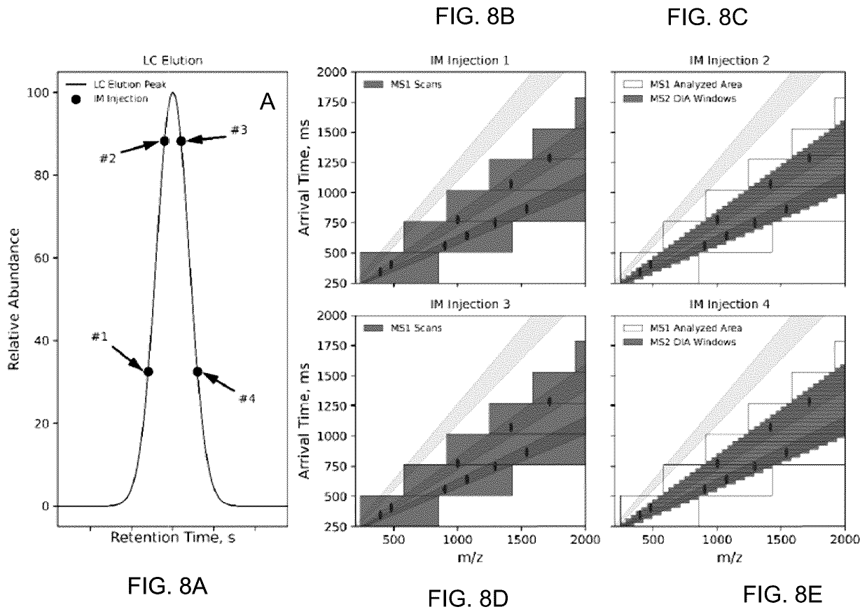

FIG. 8 summarises various concepts of methods described herein. As shown in FIG. 8A, for an eluting LC peak (black trace in FIG. 8A), multiple IM injections are performed across the peak profile (black dots in FIG. 8A, where the label corresponds to the IM injection number). These IM injections are analysed in an alternating fashion where the acquisition scheme switches between MS1 and MS2 scans. Thus, in FIG. 8B the first IM injection comprises multiple MS1 scans, in FIG. 8C the second IM injection comprises multiple MS2 scans, in FIG. 8D the third IM injection comprises multiple MS1 scans, and in FIG. 8D the fourth IM injection comprises multiple MS2 scans.

In the example of FIG. 8, the 2+ and 3+trendlines are targeted by both the MS1 and MS2 scans. However in general, the region of arrival time-m/z space targeted by the MS1 and MS2 scans can vary.

In addition to embodiments comprising two IM injections per cycle (where the first IM injection collects MS1 scans and the second IM injection collects all the MS2 scans), multiple MS2-focused IM injections can be integrated into each cycle. That is, the method cycle can be modified to have multiple IM injections that collect MS2 scans, e.g. where each IM injection for MS2 analysis can focus on a different charge state trendline.

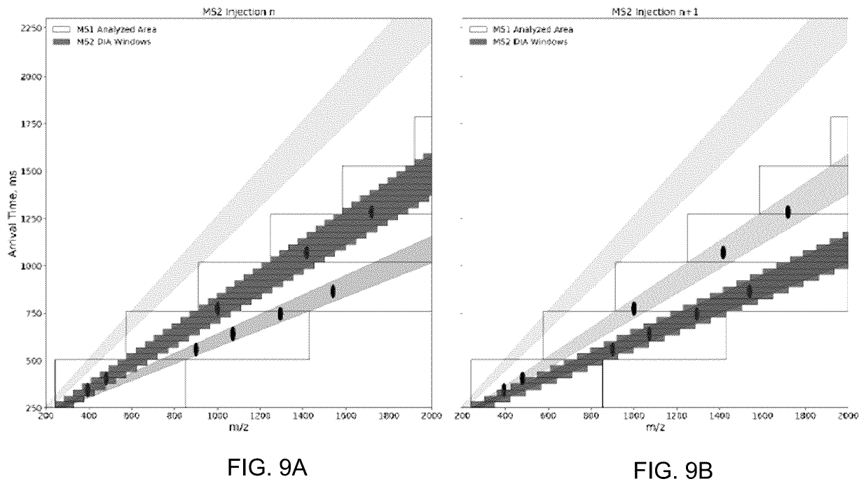

FIG. 9 illustrates an example where the first IM injection in which MS1 scans are collected (see FIG. 5) is followed by two separate MS2-focused IM injections. In this example, the 2+ and 3+ ions are of most interest, resulting in the following acquisition cycle for sequential IM injections: (i) MS1 Scans, (ii) MS2 Scans: 2+Focused, (iii) MS2 Scans: 3+Focused. Thus, the first MS2 IM injection (FIG. 9A) directs the mass filter to the 2+trendline, and the second injection (FIG. 9B) directs the mass filter to the 3+trendline. This cycle can be repeated for the entire LC gradient.

It will be understood that the above-described methods are illustrative of the general concepts described herein, and that many alternative methods in accordance with embodiments are possible.

One limitation with any MS analysis is the upper limit of the number of ions a mass spectrometer can store prior to space-charge, i.e., the repulsion of like charges stored within a physical space, leading to negative effects. In Orbitrap™ instruments, this storage limit is typically dictated by the space-charge capacity of the so-called “C-trap” from which packets of ions are injected into the Orbitrap™ mass analyser for mass analysis.

In some embodiments, to ensure the optimal sensitivity of a MS analysis, the ions transmitted to and stored in the C-trap should be “information-rich”. Typically, such “information-rich” ions in proteomics analyses are multiply charged, while background, contaminating ions are often singly charged. Therefore, it can be analytically advantageous to fill the C-trap with multiply charged ions and to discharge singly charged species, which would contribute to the space-charge capacity if transmitted.

As described above, IM separation of analytes results in charge-state-dependent trendlines (see FIG. 3). These trendlines can be mapped using a calibration procedure, e.g. as described in co-pending application U.S. 63/468,170. Thus, as there is a priori knowledge of the trendlines whose slope and intercept should be stable with consistent IM analyser settings, this information can be used to focus the mass filter 30 of the mass spectrometer to eliminate singly charged ions and transmit multiply charged ions for each MS1 or MS2 scan. This feature is utilised throughout the examples described above and depicted in FIGS. 5 through 9.

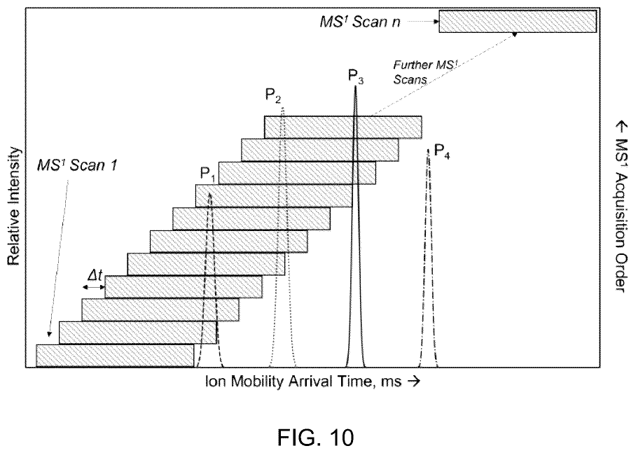

FIG. 10 illustrates schematically one possible such calibration scheme. As shown in FIG. 10, the calibration procedure takes a known set of analytes, e.g., P1, P2, P3, P4, separates these ions with IM and analyses the arrival time distribution with multiple MS1 scans over the IM cycle (macro-scan), where MS1 scans in each subsequent macro-scan are delayed by a known amount (Δt). In other words, in order to determine the arrival time of each peptide more accurately, the ion mobility separation is repeated numerous times and the start of the MS1 scan, and thus the effective arrival time bin analysed, is shifted by a known delay Δt. This process is repeated until the MS1 scan transient window has reached the estimated maximal arrival time (“MS1 Scan n”) at the end of macro-scan. In other words, the number of MS1 scans is repeated at increasingly long delays until the sliding transient window reaches the desired maximal arrival time “MS1 Scan n”.

After acquisition of these mass spectra, the extracted ion chromatogram of each peptide can be determined as a function of MS1 scan number. The scan numbers can be correlated to effective arrival time and the arrival time of each peptide can be determined.

The resulting “calibrated” arrival time versus relative intensity for P1, P2, P3 and P4 can then be determined. This information, arrival time as a function of m/z and charge state, can then be used to direct the mass filter centre m/z during the DIA run, in the manner described above. This calibration relies on the similarity of analytes of the same chemical class, e.g., tryptic peptides, groups of proteins, groups of lipids, groups of metabolites, etc., as there is a correlation between arrival time and m/z, as well as charge-state dependencies that form charge-dependent trendlines relating these two variables. Thus, after applying the calibration procedure to a known analyte mixture, the charge-state trendlines in IM versus m/z and z space can be determined and used for an unknown analyte of the same class separated with the same IM conditions.

Although various particular embodiments have been described above, various alternative embodiments are possible.

For example, the trendline(s) analysed during MS2 scans can be varied with different applications or multiple MS2-focused IM injections can be utilised.

In the embodiments described above, the mass filter isolation windows are directed by a uniform buffer around the calibration-established trendline, where the buffer region is shown by the shaded area centred around the dashed trendline for each charge state in FIG. 3. However, this buffer does not have to be uniform.

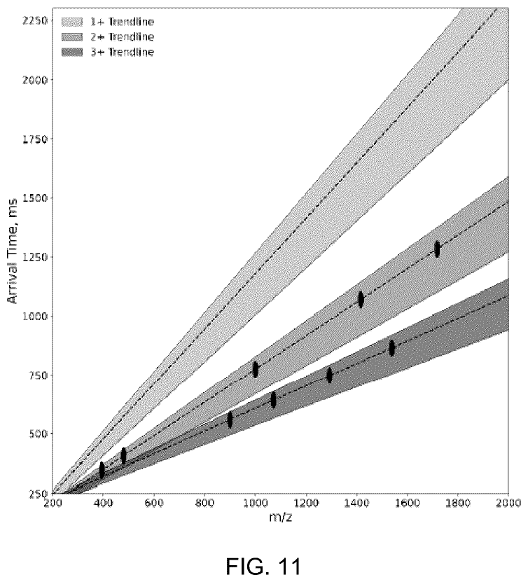

FIG. 11 shows an example in which the buffered regions (the shaded region encompassing each dashed trendline) which direct the mass filter isolation during the MS1 and MS2 scans are asymmetric. In particular, in FIG. 11, the upper boundary of a charge-state buffered region is defined by 107.5% of the trendline slope and the lower boundary is defined by 85% of the trendline slope. Other distributions can be used, and e.g. this buffer distribution can be tuned for specific applications.

Furthermore, while in the embodiments described above, the mass filter isolation windows get wider at longer arrival times as the upper and lower buffer regions expand away from the centre trendline, a fixed quadrupole isolation width can instead be used to along the trendline(s).

In some embodiments, the MS1 scans can be intelligently used to direct the MS2 scans, e.g., to direct MS2 scans to either prioritize or ignore the 3+trendline due to the abundance of 3+ ions in the MS1 scans, and e.g. to make predictions related to number of ions, e.g., for automatic gain control (AGC).

It will be understood from the above that embodiments provide a new acquisition order for MS1 and MS2 scans in a DIA workflow. As described above, in a conventional DIA workflow, a single, wide m/z range MS1 scan is followed by several narrow m/z MS2 scans, and this cycle is repeated throughout the LC gradient. With the addition of ion mobility, however, such an acquisition strategy cannot be used. To overcome this, embodiments collect all MS1 scans in a sequential way during a single IM injection. Then, on the subsequent IM injection(s), the MS2 scans are acquired.

In addition to this scan ordering, some embodiments utilise the charge-state separation afforded by IM to maximize the “information-rich” ions stored in the ion trap (e.g. C-trap) prior to mass analysis by directing the mass filter to only transmit m/z regions as directed by the trendlines of multiply charged ions. That is, embodiments maximize the utilisation of the space-charge capacity of the ion trap (e.g. C-trap) by only transmitting regions of the arrival time-m/z space that have multiply charged, “information-rich” ions.

Embodiments allow for correlation of MS1 and MS2 scans when a DIA workflow is used with an LC-IM-MS instrument configuration. This instrument configuration is beneficial as the addition of IM boosts the duty cycle, and inherently the sensitivity, as compared to non-IM MS workflows.

Although particular embodiments described above provide methods that isolate either all the “information rich” ions that are arriving at a given instant (FIG. 8), or a subset thereof following charge-state-dependent trendlines of ion arrival times (FIG. 9), further embodiments are provided.

It has been recognised that, in some circumstances, the approach that involves the selection of all “information-rich” ions arriving at any given moment can perform poorly due to an overabundance of distinct peptides contained within the isolation windows. This can result in overly complicated fragmentation spectra that hinders interpretation by processing software.

Equally, the approach that selects ions along individual charge-state-dependent trendlines can suffer from an unevenness of sample selection, with some regions of the arrival-time versus m/z space being sampled multiple times and other regions not being sampled at all. This is because the trendlines are merely trendlines—not all ions of interest arrive precisely on the trendline. In some cases there is significant deviation, e.g., to the point where the entire region between the 2+trendline and the 3+trendline can contain ions of interest.

Thus, various further embodiments provide a method to allow for complete coverage of the ions of interest, without overloading the processing software with overly complicated fragmentation spectra. To do this, the method described above is generalised by dividing the MS2 DIA sampling windows, e.g. as shown in FIG. 8, into an arbitrary number of smaller isolation windows, with each set of windows being selected by subsequent injections of ions into the ion mobility device.

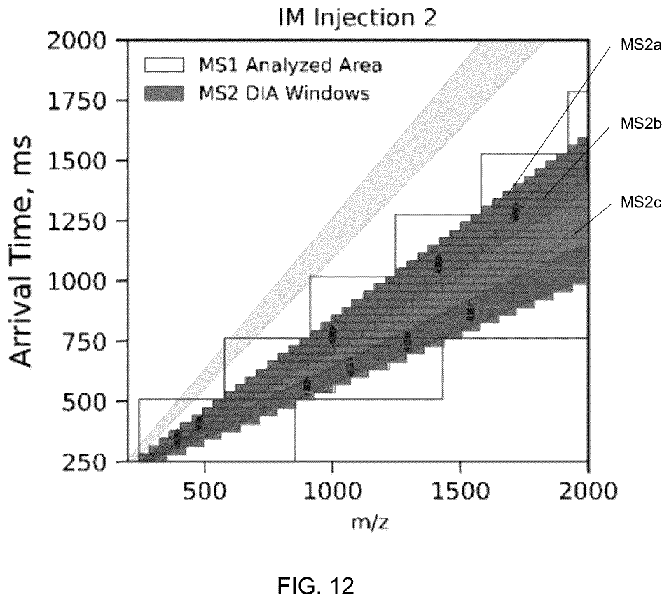

FIG. 12 shows an example of such a method, with the MS2 isolation windows divided into three sets (referred to as isolation window sets MS2a MS2b and MS2c). Isolation window set MS2a may be selected on a first ion injection into the ion mobility device, isolation window set MS2b may be selected on a second ion injection, and isolation window set MS2c may be selected on a third ion injection.

This approach provides for complete coverage of the arrival time versus m/z space of interest but allows for smaller isolation windows to reduce the number of distinct peptides being analysed within any given scan. In other words, embodiments provide a method by which the number of peptides present in any given fragmentation scan is reduced, allowing for successful deconvolution of the result MS2 spectra.

Thus, in embodiments, multiple MS2-focused IM injections may be used after the initial MS1-focused IM injection, where the MS2 isolation window for a given arrival time is divided by the number of MS2-focused IM injections. For example, if the MS2 scan for arrival time 250-282 ms would isolate m/z range 300-400 m/z in a single MS2-focused IM injection strategy, the method may perform three separate MS2-focused IM injections where this 300-400 m/z range is subdivided across the three IM separations, i.e. for the first MS2-focused IM injection, the MS2 scan would isolate 300-333.3 m/z, the second MS2-focused IM injection would isolate 333.3-366.6 m/z and the final MS2-focused IM injection would isolate 366.6 to 400 m/z.

This method can be generalized to an arbitrary number of isolation windows. The example above describes the MS2 space being divided into three sets, but it could be any number of sets, such as two sets, four sets or more than four sets.

In this method, the m/z width of each of the original MS2 windows may be divided equally among the plural sets. Alternatively, the sizing of the smaller windows may be varied, e.g. to allow for varying density of distinct peptides in the arrival-time versus m/z space. This variable window spacing may be performed based on calibration data collected using the calibration routine, e.g. as described in U.S. 63/468,170, such that regions of the arrival-time versus m/z space with a higher density of peptides arriving have narrower isolation windows and regions with a lower density of peptides arriving have wider windows.

Although the above example describes three sets of MS2 scans being collected sequentially, this does not necessarily need to be the case, and other acquisition orders are possible. For example, the instrument may alternate between MS1 scans and different sets of MS2 scans (for example, MS1, MS2a, MS1, MS2b, MS1, MS2a, and so on), or, e.g. for a larger number of sets, it may collect a multitude of sets of MS2 between each MS1 set (e.g., MS1, MS2a, MS2b, MS1, MS2c, MS2d, and so on).

In further embodiments, the spectral complexity (number of MS2 peaks) may be tuned by optimizing the number of sets, and/or the m/z coverage window (variable or identical) for each of them. The maximal spectral complexity acceptable may be determined by limitations on the data processing software to automatically extract protein identifications and may vary dependent on the particular algorithms/software package deployed.

The embodiments described so-far allow for good correlation between MS1 and MS2 scans and effectively utilize both the LC and IM separation prior to MS analysis. Further embodiments do this while also utilizing the data in a real-time fashion, e.g., by utilizing the information obtained during the MS1 scans to drive the MS2 scans or the order in which they are collected.

In some embodiments, the IM-MS DIA methods are driven by the estimated boundaries of charge state trendlines to direct the quadrupole m/z isolation area. However, in some cases, ions may not be uniformly distributed across this m/z space. There can be narrow m/z regions of many precursor ions and wide m/z regions of relatively few precursor ions. This information is not known until the arrival time distribution is measured by an MS1 scan.

Various further embodiments provide a method that utilizes this MS1 scan information to intelligently drive the MS2 scan order to maximize the utility of the ions and minimize the amount of instrument time wasted on sparse m/z regions while the LC peak is eluting to the MS.

In these embodiments, as the MS1 scans arrive they are analysed, e.g. by the instrument's control system (internal PC), to determine metrics about precursor ion distribution as a function of m/z, charge state, and intensity (non-inclusive list). This information is then used to drive the acquisition scheme of the subsequent MS2-focused IM injections. One example of this “intelligent” acquisition scheme is the determination of the number of ions in the various m/z isolation bins.

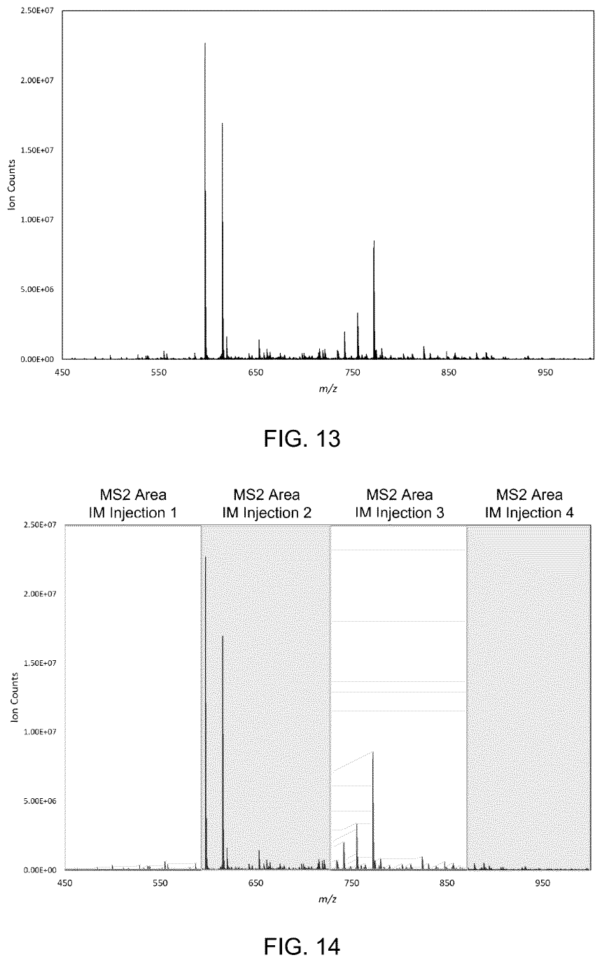

FIG. 13 shows an example of a spectrum obtained from an MS1 scan with an area of 450-1000 m/z for a certain arrival time window. A wide distribution of precursor ions can be seen within the m/z region of interest, 450-1000 m/z. However, the precursor ions are not equally distributed across this m/z space. Namely, there is a much denser distribution of ions, and therefore precursors, in the 550 to 850 m/z range as compared to the areas of 450-550 m/z and 850-1000 m/z.

If the overall area was analysed by four consecutive MS2-focued IM injections (e.g. as described above with respect to FIG. 12), the range of 450-1000 m/z would be divided equally across the four separate IM injections as shown in FIG. 14 (where “MS2 Area” describes the quadrupole isolation window for that particular IM injection). Thus, FIG. 14 shows, superimposed over the MS1 spectrum of FIG. 13, the various quadrupole isolation areas that would be analysed with a four MS2-focused IM injection strategy. With this strategy, the quadrupole isolation window is shifted across the entire m/z range progressively with each incremental IM injection.

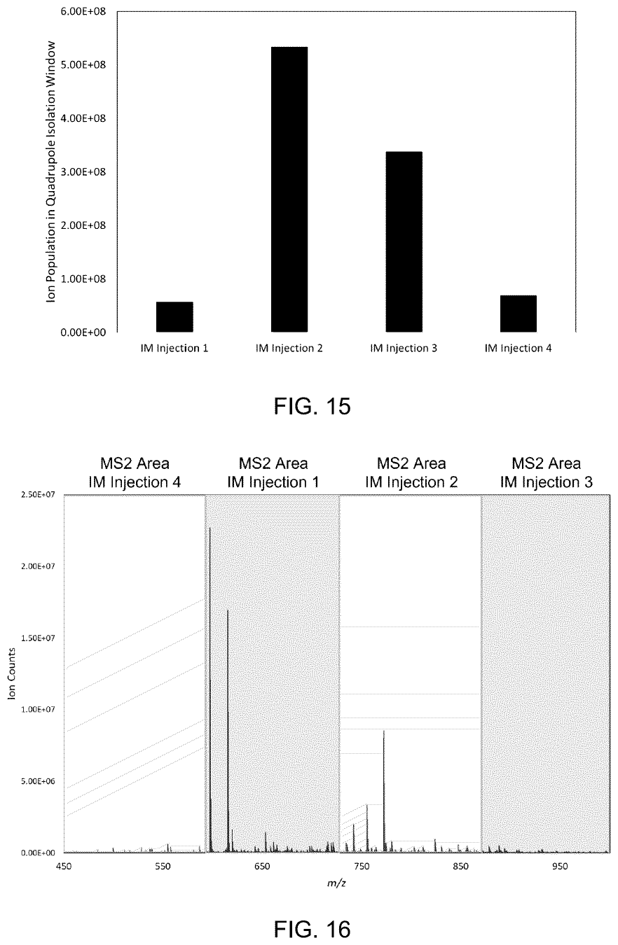

FIG. 15 shows ion populations as a function of MS2 areas for the FIG. 14 scheme. It can be seen that the area scheduled to be covered by IM injection 2 has the most ion signal density, followed by the area for IM injection 3, while the areas of injection 1 and 4 have an order of magnitude less signal. Thus, the acquisition method shown in FIG. 14 results in an asymmetric ion load distribution in the four individual IM injections.

In embodiments, using this data (which can be determined in real time, e.g., as the MS1 scan arrives to the internal instrument PC), the method prioritizes the areas based on cumulative signal intensity present in the MS1 scan for that quadrupole isolation area. In the example of FIGS. 14 and 15, this would result in the IM acquisition order shown in FIG. 16.

Thus, with the ion load per quadrupole isolation region determined in real-time from the MS1 scan, the regions can be ranked from most populated to least populated (e.g., similarly to a “Top-N” method with DDA), and then acquired in this order. This ensures that the region with the most information is acquired first. In the case of a peptide distribution that is almost completely eluted from the LC column, this may ensure that the instrument time is utilized wisely.

It should be noted that a most to least abundant acquisition scheme is not the only possible strategy. For example, it may be beneficial to acquire least populated to most populated for some applications, e.g. where low abundance analytes are of particular interest.

Further utilization of the MS1 data can be realized by determining the isolation windows needed to have an equal ion load in each of the n-number IM injections, which in this example case is four IM injections.

To do this, the total ion current (TIC) for an MS1 scan may be calculated, and this TIC may be divided by the number, n, of MS2-focused IM injections established for the DIA method (e.g. as chosen by the user). Then, based on the MS1-specific m/z distribution, isolation windows that reach the TIC/n numbers of ions may be calculated. The quadrupole isolation windows may be calculated in real time to establish this distribution by varying the width of each.

For the MS1 scan shown in FIG. 13, the TIC is 1×10⁹, which would result in a target ion load per isolation area in an IM injection of 2.5×10⁸ for n=4 MS2-focused IM injections.

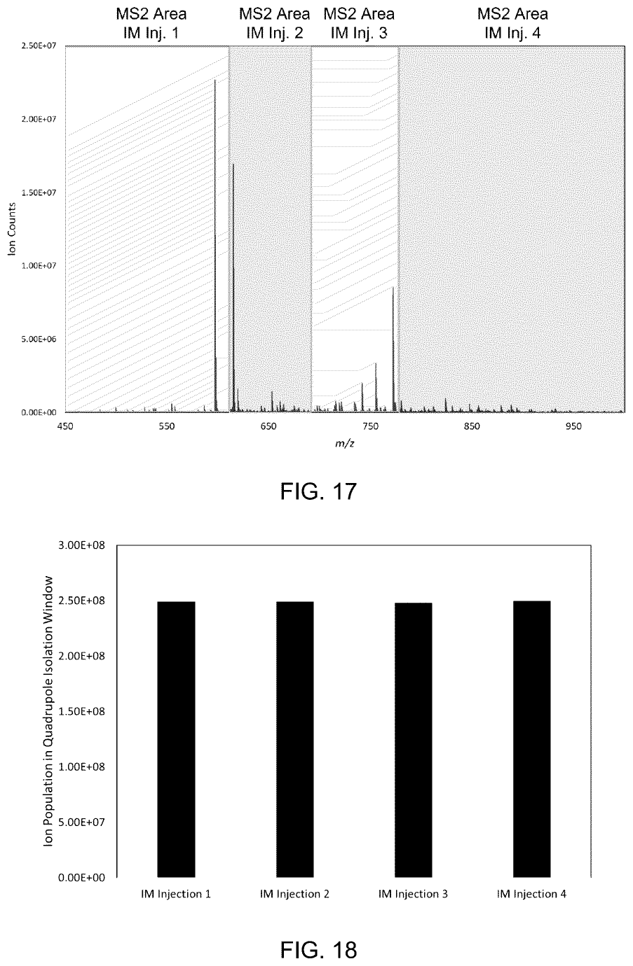

Calculating windows that give rise to this distribution of ion load results in the isolation windows that are graphical shown in FIG. 17. Here, the windows are not equally spaced, but each isolation area has an equal amount of ion load, as illustrated by FIG. 18. It can be seen from FIG. 18 that, by calculating varying window sizes, the ion load is equally distributed across the four IM injections. This approach may avoid over filling a certain MS2 scan, while other MS2 scans are unfilled.

Furthermore, as shown by FIG. 8, often the mass resolutions used for MS1 and MS2 scans are different, which results in a differing arrival time distributions being analysed by a single MS1 and MS2 scan. Namely, in the example presented in FIG. 8, there are eight MS2 scans that analyse the same arrival time range as the single MS1 scan. The data contained in the MS1 scan covers arrival times that would be analysed by multiple MS2 scans on subsequent IM injections due to the differences in transient lengths.

As the data available will be from the MS1 level and thus be the combination of all arrival times within this region, the charge-state dependent trendline data (e.g. as determined by the calibration method) can be used combined with the charge state of a precursor and that precursor's m/z to determine which arrival time bin, i.e. which of the eight MS2 scans, it would be expected to arrive in. This can be done when performing either of the two real-time decision-making choices described above. These calculations can also be used to implement AGC control for the various MS2 scans by calculating expected ion populations and/or adjusting IM-fill time and also ion injection times in the MS.

It will be understood that embodiments utilize real-time decision making from the collected MS1-level to drive how MS2 scans are acquired. Embodiments can more wisely utilize instrument time to direct the instrument to focus on regions of high ion load first rather than solely driven by a predetermined, MS1-independent m/z window order. Alternatively, embodiments can directly balance the ion load of various IM injections to avoid underfilling a single IM injection or overfilling another. Furthermore, embodiments can be utilized to determine AGC control for MS2 scans on subsequent IM injections.

Although various embodiments have been described above particularly in terms of ion mobility separation, it would be possible to perform the method using any type of ion separation technology in which ions are separated according to a (“first”) physico-chemical property. For example, the method may be performed using ion mobility separation, differential ion mobility separation, or mass to charge ratio (m/z) separation. Suitable types of ion separator include but are not limited to the examples described in the following documents, each of which is incorporated herein by reference in its entirety:

1. Ion separation devices configured to sort ions by m/z, e.g. as described in U.S. Pat. No. 10,256,088. An RF voltage is applied across each electrode of a first array of evenly spaced, parallel, and coplanar electrodes and its corresponding electrode of a second array of evenly spaced, parallel, and coplanar electrodes. The RF voltage varies in amplitude according to an RF voltage amplitude gradient. The RF voltage produces an array of different quadrupole RF electric fields in a uniform gap between the first array and the second array. A DC voltage is superimposed on each electrode of the first array and its corresponding electrode of the second array. The DC voltage varies according to a DC voltage gradient in order to produce a DC electric field in the uniform gap. When ions are introduced in the uniform gap, the DC electric field causes the ions to drift toward quadrupole RF electric fields with increasing RF voltage amplitudes where the ions are trapped according to their m/z.

2. Ion traps, or ion trap arrays, e.g. as described in U.S. Pat. No. 9,111,741. An ion storing apparatus may be configured to separate ions by mass-to-charge ratio. An ion trap may comprise at least two or more rows of parallel placed electrode arrays, wherein each electrode array includes at least two or more parallel bar-shaped electrodes. By applying different phase of alternating current voltages on different bar electrodes to create alternating electric fields inside the space between two parallel electrodes of different rows of electrode arrays, multiple linear ion trapping fields are formed in the space between the different rows of electrode arrays which are open to adjacent each other without a real barrier.

3. Separation devices that use “Zeno pulsing” techniques, e.g. as described in the article “A W-Geometry Ortho-TOF MS with High Resolution and Up to 100% Duty Cycle for MS/MS”, J. Am. Soc. Mass Spectrom., 2009, 20, pp. 1342-13.

4. Stacked well ion traps, e.g. as described in U.S. Pat. No. 7,872,228. A plurality of electrodes may be positioned and driven by RF potentials to form a plurality of adjacent pseudopotential wells. Ions may be manipulated, reacted, analysed, and ejected from the apparatus in a manner similar to conventional ion traps. In addition, selected ions or groups of ions may be passed from one pseudopotential well to another pseudopotential well without ion losses due to physical obstructions.

5. Orthogonal-flow ion trap arrays, e.g. as described in U.S. Pat. No. 10,651,025. The ion separation device may comprise a plurality of electrodes arranged in a two-dimensional grid, a gas supply configured to provide a gas flow along the first direction, and an ion inlet arranged to receive ions. The plurality of electrodes may be configured to create one or more pseudopotential barriers of increasing magnitude along a first direction. A drag force may be applied to the ions by the gas flow is opposed by a pseudopotential gradient of the plurality of electrodes.

6. Annular traps, e.g. as described in US Patent Application No. U.S. Ser. No. 18/090,730. A system for sorting ions has a group of multipole electrodes configured to form an ion trap, and an ion guide adjacent to the group of multipole electrodes. An RF and DC voltage device is used to apply an RF voltage to the group of multipole electrodes thereby creating a pseudo-potential barrier configured to confine one or more ions. The RF and DC voltage device is also used to apply a DC voltage that creates an axial field in opposition to the pseudo-potential barrier at the exit of the trap. The RF voltage or DC voltage is then ramped up or down, depending on the use case to cause at least one ion to be eluted across the pseudo-potential barrier.

7. Ion centrifuge ion separation devices, e.g. as described in European Patent Application No. EP 4,020,524. An ion separation apparatus may comprise: (a) first and second ion carpets, each comprising: a substrate having first and second faces; and a set of electrodes disposed on or beneath the first face, wherein a configuration of a first plurality of the set of electrodes defines at least one group of circle sectors; (b) an ion exit aperture passing through one ion carpet; and (c) one or more power supplies configured to provide radio frequency voltages to a first subset of the electrodes of each ion carpet, to provide electrical potential differences across electrodes of the first subset of electrodes of each ion carpet, and to provide time-varying voltages to the first plurality of electrodes of each ion carpet that migrate through the sectors as a traveling wave, wherein the ion carpets are disposed parallel to one another with a gap therebetween, the first faces facing one another across the gap.

8. Ion mobility separation devices that use a lens array, e.g. as described in U.S. Pat. No. 11,119,070. A mobility separator includes a two-dimensional grid of electrodes spanning a passage between first and second walls. The first and second walls include an inlet aperture and a plurality of exit apertures, respectively. The two-dimensional grid of electrodes is configured to generate an electric field within the passage. The plurality of ion channels arranged adjacent to the plurality of exit apertures. Movement of ions between the inlet aperture and the plurality of exit apertures are governed by the electric field and a gas flow through the passage between to the first and second walls such that the ions are sorted and directed to different channels based on their respective mobility.

9. Trapped Ion Mobility Separation (T_{IMS}) devices, e.g. as described in the article Meier, F. et al. Parallel Accumulation-Serial Fragmentation (PASEF): Multiplying Sequencing Speed and Sensitivity by Synchronized Scans in a Trapped Ion Mobility Device; Journal of Proteome Research 2015, 12, 5378-5387.

Although the present invention has been described with reference to various embodiments, it will be understood that various changes may be made without departing from the scope of the invention as set out in the accompanying claims.

1. A method of operating an analytical instrument comprising:
ionising a sample to produce sample ions;
(i) performing a first ion separation scan by separating sample ions according to a first physico-chemical property, and analysing the separated sample ions by performing one or more MS1 mass analysis scan(s); and
(ii) performing a second ion separation scan by separating sample ions according to the first physico-chemical property, and analysing the separated sample ions by performing a plurality of MS2 mass analysis scans, wherein each MS2 scan of the plurality of MS2 mass analysis scans uses one MS2 isolation window of a plurality of MS2 isolation windows;
analysing MS1 data acquired from the one or more MS1 mass analysis scan; and
configuring the plurality of MS2 isolation windows based on the analysis of the MS1 data.

2. The method of claim 1, wherein:
the plurality of MS2 mass analysis scans is a first plurality of MS2 mass analysis scans, and the plurality of MS2 isolation windows is a first plurality of MS2 isolation windows; and
the method further comprises:
configuring a second plurality of MS2 isolation windows based on the analysis of the MS1 data; and
(iii) performing a third ion separation scan by separating sample ions according to the first physico-chemical property and analysing the separated sample ions by performing a second plurality of MS2 mass analysis scans, wherein each MS2 scan of the second plurality of MS2 mass analysis scans uses one MS2 isolation window of the second plurality of MS2 isolation windows.

3. The method of claim 2, wherein the method further comprises:
configuring a third plurality of MS2 isolation windows based on the analysis of the MS1 data; and
(iv) performing a fourth ion separation scan by separating sample ions according to the first physico-chemical property and analysing the separated sample ions by performing a third plurality of MS2 mass analysis scans, wherein each MS2 scan of the third plurality of MS2 mass analysis scans uses one MS2 isolation window of the third plurality of MS2 isolation windows.

4. The method of claim 3, wherein configuring the MS2 isolation windows comprises:
for each of one or more or all of the first plurality of MS2 isolation windows: configuring that MS2 isolation window, based on the MS1 data, to include a higher abundance of ions than a corresponding one of the second plurality of MS2 isolation windows; and/or
for each of one or more or all of the second plurality of MS2 isolation windows: configuring that MS2 isolation window, based on the MS1 data, to include a higher abundance of ions than a corresponding one of the third plurality of MS2 isolation windows.

5. The method of claim 4, further comprising:
for each of one or more or all of the second plurality of MS2 isolation windows: configuring that MS2 isolation window to have a width equal to or approximately equal to the width of the corresponding one of the first plurality of MS2 isolation windows; and/or
for each of one or more or all of the third plurality of MS2 isolation windows: configuring that MS2 isolation window to have a width equal to or approximately equal to the width of the corresponding one of the first plurality of MS2 isolation windows.

6. The method of claim 3, wherein configuring the MS2 isolation windows comprises:
for each of one or more or all of the second plurality of MS2 isolation windows: configuring that MS2 isolation window, based on the MS1 data, to include a same or similar abundance of ions to a corresponding one of the first plurality of MS2 isolation windows; and/or
for each of one or more or all of the third plurality of MS2 isolation windows: configuring that MS2 isolation window, based on the MS1 data, to include a same or similar abundance of ions to a corresponding one of the first plurality of MS2 isolation windows.

7. The method of claim 6, wherein analysing the MS1 data and configuring the MS2 isolation windows comprises:
determining a total ion current indicated by the MS1 data; and
for each of one or more or all of the second plurality of MS2 isolation windows: configuring that MS2 isolation window, based on the MS1 data, to include an equal or approximately equal share of the total ion current as a corresponding one of the first plurality of MS2 isolation windows; and/or
for each of one or more or all of the third plurality of MS2 isolation windows: configuring that MS2 isolation window, based on the MS1 data, to include an equal or approximately equal share of the total ion current to a corresponding one of the first plurality of MS2 isolation windows.

8. The method of claim 1, wherein:
the MS2 isolation windows are configured such that the MS2 mass analysis scans together cover a region of ion arrival time-m/z space of interest; and
the region of ion arrival time-m/z space of interest corresponds to one or more trend lines of interest, wherein each trend line corresponds to an ion charge state and/or chemical class, and wherein each trend line provides a relationship between ion arrival time and m/z for ions having that charge state and/or of that chemical class.

9. The method of claim 1, wherein:
each MS2 isolation window is configured based on one or more trend lines, wherein each trend line corresponds to an ion charge state and/or chemical class of interest, and wherein each trend line provides a relationship between ion arrival time and m/z for ions having that charge state and/or of that chemical class; and
configuring the plurality of MS2 isolation windows comprises selecting the charge state(s) and/or chemical class of interest based on the analysis of the MS1 data.

10. The method of claim 1, wherein:
in each MS2 mass analysis scan, ions are accumulated in an ion store for an accumulation time; and
the method further comprises determining the accumulation time for one or more or each MS2 scan based on the analysis of the MS1 data.

11. A method of operating an analytical instrument comprising:
ionising a sample to produce sample ions;
(i) performing a first ion separation scan by separating sample ions according to a first physico-chemical property, and analysing the separated sample ions by performing one or more MS1 mass analysis scan(s); and
(ii) performing a second ion separation scan by separating sample ions according to the first physico-chemical property, and analysing the separated sample ions by performing a plurality of MS2 mass analysis scans, wherein in each MS2 mass analysis scan, ions are accumulated in an ion store for an accumulation time;
wherein the method further comprises:
analysing MS1 data acquired from the one or more MS1 mass analysis scan(s); and
determining the accumulation time for one or more or each MS2 scan based on analysis of the MS1 data.

12. The method of claim 11, wherein the method comprises performing a plurality of MS1 mass analysis scans during the first ion separation scan, and wherein:
in each MS1 mass analysis scan of the plurality of MS1 mass analysis scans, separated sample ions are isolated using an MS1 isolation window, and the isolated sample ions are mass analysed; and
each MS1 scan of the plurality of MS1 mass analysis scans uses one MS1 isolation window of a plurality of MS1 isolation windows, optionally wherein each MS1 isolation window is selected based on one or more trend lines.

13. The method of claim 12, wherein determining the accumulation time for an MS2 scan comprises:
using the one or more trend lines and the MS1 data to estimate an ion abundance within an MS2 isolation window for the MS2 scan; and
determining the accumulation time for the MS2 scan based on the estimated ion abundance.

14. The method of claim 1, wherein the first physico-chemical property is ion mobility, differential ion mobility, or mass to charge ratio (m/z).

15. The method of claim 1, wherein the method comprises the analytical instrument performing a plurality of repeated cycles, wherein in each cycle the analytical instrument performs steps (i) and (ii).

16. The method of claim 3, wherein the method comprises the analytical instrument performing a plurality of repeated cycles, wherein:
in each cycle the analytical instrument performs steps (i), (ii) and (iii); or
in each cycle the analytical instrument performs steps (i), (ii), (iii) and (iv).

17. The method of claim 16, wherein:
the sample is provided from a chromatographic separation device; and
the method comprises the analytical instrument continuously performing repeated cycles during a chromatographic separation of the chromatographic separation device.

18. A non-transitory computer readable storage medium storing computer software code which when executed on a processor performs the method of claim 1.

19. An analytical instrument comprising:
an ion source configured to ionise a sample to produce sample ions;
an ion separator configured to separate sample ions according to a first physico-chemical property;
a mass filter configured to filter ions using an isolation window;
a fragmentation device configured to fragment sample ions so as to produce fragment ions;
a mass analyser; and
a control system configured to:
(i) cause the analytical instrument to perform a first ion separation scan by separating sample ions according to the first physico-chemical property, and analysing the separated sample ions by performing one or more MS1 mass analysis scan(s); and
(ii) cause the analytical instrument to perform a second ion separation scan by separating sample ions according to the first physico-chemical property, and analysing the separated sample ions by performing a plurality of MS2 mass analysis scans, wherein each MS2 scan of the plurality of MS2 mass analysis scans uses one MS2 isolation window of a plurality of MS2 isolation windows;
wherein the control system is further configured to:
analyse MS1 data acquired from the one or more MS1 mass analysis scan(s); and
configure the plurality of MS2 isolation windows based on the analysis of the MS1 data.

20. The analytical instrument of claim 19, wherein:
the ion separator is an ion mobility separator, and the first physico-chemical property is ion mobility;
the ion separator is a differential ion mobility separator, and the first physico-chemical property is differential ion mobility; or
the ion separator is configured to separate ions according to their mass to charge ratio (m/z), and the first physico-chemical property is a mass to charge ratio (m/z).
